(19) United States
(12) Patent Application Publication
(10) Pub. No.: US 2026/0239160 A1
(43) Pub. Date: Aug. 13, 2026

(54) ACCESS FUNCTION (AF) PROVIDING USER EQUIPMENT (UE) ROUTE SELECTION POLICY (URSP) RULES FOR ROAMERS

(71) Applicant: Telefonaktiebolaget LM Ericsson (publ), Stockholm (SE)

(72) Inventors: Maria Belen PANCORBO MARCOS, Madrid (ES); David CASTELLANOS ZAMORA, Madrid (ES); Antonio INIESTA GONZALEZ, Madrid (ES); Ping CHEN, Shanghai (CN)

(21) Appl. No.: 19/154,542

(22) PCT Filed: Feb. 9, 2024
(86) PCT No.: PCT/IB2024/051242

§ 371 Date: Aug. 7, 2025

Related U.S. Application Data
(60) Provisional application No. 63/484,294, filed on Feb. 10, 2023.

(51) Int. Cl. H04W 40/20; H04W 8/12

(52) U.S. Cl. CPC H04W 40/20; H04W 8/12

(57) ABSTRACT

A method, system and apparatus are disclosed. A network node is configured to determine a request for guidance on a rule determination associated a wireless device roaming, the determined request including at least one service parameter and a network identifier, the at least one service parameter being applicable to at least one user of a network associated with the network identifier. The network node is configured to cause transmission of the request for guidance on the rule determination.

### TECHNICAL FIELD

The present disclosure relates to wireless communications, and in particular, to determination of routing rules associated with wireless devices.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD)(e.g., user equipment (UE)), as well as communication between network nodes and between WDs. The 3GPP is also developing standards for Sixth Generation (6G) wireless communication networks.

A network node may comprise one or more functions such as an access function (AF), a policy control function (PCF), etc. When an AF provides guidance on UE route selection policy (URSP) rules to a home public land mobile network (HPLMN), a home PCF (H-PCF) generates URSP rules that are applicable to any PLMN where a WD (e.g., UE) is roaming. A study associated with 3GPP Release 18 (Rel-18) describes how to indicate to the WD a list of URSP Rules that apply when roaming in a PLMN. The AF can also indicate that the AF guidance on URSP rule determination applies when a WD, a group of WDs or any WD of the PLMN is roaming and which PLMN(s). In addition, the AF can provide AF guidance on URSP rule determination targeting any roaming user of a PLMN identifier (ID).

Further, a Data Key may be extended with the PLMN ID as indicated in Table 1.

TABLE 1
Example of data key extension

| | | | |
|---|---|---|---|
| Application | Packet Flow Descriptions | Application Identifier | — |
| data | (PFDs) | | |
| | AF traffic influence | AF transaction internal | |
| | request information | ID | |
| | (See clause 5.6.7 and | S-NSSAI and DNN | |
| | clause 6.3.7.2 of 3GPP | and/or | |
| | Technical Specification | Internal Group Identifier | |
| | (TS) 23.501 version | or SUPI or “any UE” | |
| | 18.0.0 dated 2022-12-21, | indication (NOTE 4) | |
| | hereinafter “3GPP TS | | |
| | 23.501”) | | |
| | Background Data Transfer | Internal Group Identifier | |
| | (NOTE 3) | or SUPI | |
| | Service specific | S-NSSAI and DNN or | |
| | information (See | Internal Group Identifier | |
| | clause 4.15.6.7 of 3GPP | or SUPI or “any UE” | |
| | TS 23.501) | indication (NOTE 4) | |
| | | and/or “PLMN ID | |
| | | (NOTE 6) | |
| | EAS Deployment | DNN and/or S-NSSAI | Application |
| | Information | | Identifier |
| | (See clause 7.1 of 3GPP | | and/or |
| | TS 23.548 version 18.0.0 | | Internal |
| | dated 2022 Dec. 21, | | Group |
| | hereinafter “3GPP TS | | Identifier |
| | 23.548”) | | |
| | AM influence information | AF transaction internal | |
| | (See clause 4.15.6.9.3 of | ID | |
| | 3GPP TS 23.548) | S-NSSAI and DNN | |
| | | and/or | |
| | | Internal Group Identifier | |
| | | or SUPI or “any UE” | |
| | | indication (NOTE 4) | |

NOTE 1: Retrieval of the stored Background Data Transfer References for all ASP identifiers in the user data repository (UDR) requires Data Subset but no Data Key or Data Subkey(s).

NOTE 2: Update of a Background Data Transfer Reference in the UDR requires a Data key to refer to a Background Data Transfer Reference as input data.

NOTE 3: The Background Data Transfer includes the Background Data Reference ID and the ASP Identifier that requests to apply the Background Data Reference ID to the UE(s) (i.e., WDs). Furthermore, the Background Data Transfer includes the relevant information received from the AF as defined in clause 6.1.2.4 of 3GPP TS 23.503 version 18.0.0 dated 2022 Dec. 21, hereinafter “3GPP TS 23.503”.

NOTE 4: When the Data Key targets “any UE”, then the request to UDR applies on Application data that applies on all subscribers of the PLMN. For encoding, see 3GPP TS 29.519 version 18.0.0 dated 2022 Dec. 16, hereinafter “3GPP TS 29.519”.

NOTE 5: Group Data includes 5G visited network (VN) group configuration and any other data related to a group stored in the UDR.

NOTE 6: For case (a) described in clause 4.15.6.10, when the Data Key targets “PLMN ID”, then the request to UDR applies on Application data that applies on all subscribers of that PLMN ID. In this case, the AF provides a PLMN ID if the request applies for all subscribers of that PLMN that can be roaming to the visited PLMN (VPLMN) the AF provides the request to. For case (b) described in clause 4.15.6.10, when the Data Key targets “PLMN ID”, then the request to UDR applies on Application data for that PLMN ID for a single UE or any UE.

To generate URSP rules applicable in the VPLMN, H-PCF may take Service Parameters obtained from the visited PCF (V-PCF) or visited AF (V-AF) as follows into account. The Service Parameters are provided by the V-AF (i.e. AF in a VPLMN) to:
a) the visited network element function (V-NEF) and stored in visited UDR (V-UDR). Therefore, the V-PCF obtains the Service Parameters from V-UDR and provides the Service Parameters to the home PCF (H-PCF).
b) the home NEF (H-NEF) and stored in the home UDR (H-UDR). Therefore, the H-PCF retrieves the Service Parameters directly from the H-UDR. In this case, it is up to the H-NEF to check whether the V-AF issuing Application guidance for URSP determination is entitled to provide guidance targeting that VPLMN.

### SUMMARY

Some embodiments advantageously provide methods, systems, and apparatuses for a network node (e.g., AF) to provide rules such as URSP rules for one or more devices and/or nodes such as roamer wireless devices.

In one or more embodiments, just having PLMNID(s) provided from AF is not enough to differentiate the cases where AF provides AF guidance on URSP rule determination to any inbound roamer of a PLMN or the cases where the AF provides AF guidance on URSP determination for target WD(s) (e.g., Target UE(s)) when roaming in a PLMN(s).

In some embodiments, a request for AF guidance on URSP rule determination (and/or the AF guidance on URSP rule determination) includes service parameters and/or VPLMN ID(s) that indicate that the service parameters are applicable to users of the PLMN of the NEF the AF provides information to, e.g., only when the WD is registered in the VPLMN (such as roaming in the VPLMN).

In some other embodiments, a service request (e.g., the Nnef_ServiceParameter service request) includes a new target WD (e.g., target UE) set to “inbound roamer of PLMN ID(s)”. Setting the new target WD as such may be used to differentiate a service request (associated to any user of the PLMN of the NEF the AF provides the information when they roam to other VPLMNs) with another service request associated to inbound roamer WDs from other PLMNs.

In some embodiments, the Nnef_ServiceParameter service request includes the PLMN ID(s) of the inbound roamers PLMNs, that the AF guidance on URSP rule determination information is associated to. One or more embodiments of the present disclosure are applicable to any service specific parameters.

On or more embodiments are beneficial at least because sending URSP Rules to the WD that are not applicable when registered in a PLMN may be avoided. Further, the network node (e.g., AF) may differentiate between cases such as when the service request applies to: a) any user of the PLMN of the NEF that the AF provides the information when roaming to other VPLMNs; or b) to inbound roamer WDs from other PLMNs.

According to an aspect, a network node configured to communicate with at least another network node and/or a wireless device (WD) is described. The network node is configured to and/or comprises a communication interface and/or processing circuitry configured to one or both of: determine a request for guidance on a rule determination associated with WD roaming, where the determined request includes one or more service parameters and a network identifier, and the one or more service parameters are applicable to one or more users of a network associated with the network identifier; and one of transmit to and receive from the at least another network node the request for guidance on the rule determination.

In some embodiments, one or more of: the guidance is an Application Function (AF) guidance; the rule determination is a user equipment route selection policy (URSP) rule determination; the network is a public land mobile network (PLMN); the network identifier is a PLMN identifier (ID) of a network exposure function (NEF) that receives information from an AF; the network node comprises the AF; and the WD is registered with the network.

In some embodiments, the network node is configured to determine a first service request including one or both of a target WD set to inbound roamer of one or more PLMN IDs and the one or more PLMN IDs of inbound roamer PLMNs associated with the guidance on rule determination.

In some other embodiments, the network node is configured to differentiate a second service request from a third service request. The second request is associated with any user of a PLMN of an NEF that an AF provides information when the WD roams to other PLMNs, the third service request being associated with inbound roamer WDs from other PLMNs.

According to another aspect, a method implemented in a network node configured to communicate with at least another network node and/or a wireless device (WD) is described. The method comprising one or both of determining a request for guidance on a rule determination associated with WD roaming, where the determined request includes one or more service parameters and a network identifier, and the one or more service parameters are applicable to one or more users of a network associated with the network identifier; and one of transmitting to and receiving from the at least another network node the request for guidance on the rule determination.

In some embodiments, one or more of: the guidance is an Application Function (AF) guidance; the rule determination is a user equipment route selection policy (URSP) rule determination; the network is a public land mobile network (PLMN); the network identifier is a PLMN identifier (ID) of a network exposure function (NEF) that receives information from an AF; the network node comprises the AF; and the WD is registered with the network.

In some other embodiments, the method further includes determining a first service request including one or both of a target WD set to inbound roamer of one or more PLMN IDs and the one or more PLMN IDs of inbound roamer PLMNs associated with the guidance on rule determination.

In some embodiments, the method further includes differentiating a second service request from a third service request. The second request is associated with any user of a PLMN of an NEF that an AF provides information when the WD roams to other PLMNs, the third service request being associated with inbound roamer WDs from other PLMNs.

According to one aspect of the present disclosure, a network node is provided. Network node is configured to determine a request for guidance on a rule determination associated a wireless device roaming, the determined request including at least one service parameter and a network identifier, the at least one service parameter being applicable to at least one user of a network associated with the network identifier. Network node is configured to cause transmission of the request for guidance on the rule determination.

According to one or more embodiments of this aspect, the guidance is an Application Function, AF, guidance.

According to one or more embodiments of this aspect, the rule determination is a user equipment route selection policy, URSP, rule determination.

According to one or more embodiments of this aspect, the network is a public land mobile network, PLMN.

According to one or more embodiments of this aspect, the network identifier is a public land mobile network, PLMN identifier, ID, of an inbound roamer.

According to one or more embodiments of this aspect, the network identifier is a visiting public land mobile network, VPLMN identifier, ID, of where the at least one service parameter applies.

According to one or more embodiments of this aspect, the request further includes at least one of: a wireless device identifier, a group identifier, and a wireless device indication corresponding to any wireless device.

According to one or more embodiments of this aspect, the network node includes the AF.

According to one or more embodiments of this aspect, the wireless device is registered with the network.

According to one or more embodiments of this aspect, the network node is further configured to determine a first service request including one or both of a target wireless device set to inbound roamer of at least one Public Land Mobile Network, PLMN, ID and at least one PLMN ID of inbound roamer PLMNs associated with the guidance on rule determination.

According to one or more embodiments of this aspect, the network node is further configured to differentiate a second service request from a third service request, the second service request being associated with at least one wireless device of a PLMN of an Network Exposure Function, NEF, that an AF provides information to when the at least one wireless device roams to other PLMNs, the third service request being associated with inbound roamer wireless devices from other PLMNs.

According to one or more embodiments of this aspect, the differentiating includes providing equipment route selection policy information that either: targets an inbound roamer from a PLMN ID; or targets an outbound roamer when the outbound roamer is roaming into a visited PLMN ID, the outbound roamer being at least one of a subscriber, a wireless device, a group of wireless devices, and any wireless device of a same PLMN of the NEF.

According to another aspect of the present disclosure, a method implemented by a network node is provided. The method includes: determining a request for guidance on a rule determination associated with wireless device roaming, the determined request including at least one service parameter and a network identifier, the at least one service parameter being applicable to at least one user of a network associated with the network identifier; and causing transmission of the request for guidance on the rule determination.

According to one or more embodiments of this aspect, the guidance is an Application Function, AF, guidance.

According to one or more embodiments of this aspect, the rule determination is a user equipment route selection policy, URSP, rule determination.

According to one or more embodiments of this aspect, the network is a public land mobile network, PLMN.

According to one or more embodiments of this aspect, the network identifier is a public land mobile network, PLMN identifier, ID, of an inbound roamer.

According to one or more embodiments of this aspect, the network identifier is a visiting public land mobile network, VPLMN identifier, ID, of where the at least one service parameter applies.

According to one or more embodiments of this aspect, the request further includes at least one of: a wireless device identifier, a group identifier, and a wireless device indication corresponding to any wireless device.

According to one or more embodiments of this aspect, the network node includes the AF.

According to one or more embodiments of this aspect, the wireless device is registered with the network.

According to one or more embodiments of this aspect, the method further includes: determining a first service request including one or both of a target wireless device set to inbound roamer of at least one Public Land Mobile Network, PLMN, ID and at least one PLMN ID of inbound roamer PLMNs associated with the guidance on rule determination.

According to one or more embodiments of this aspect, the method further includes: differentiating a second service request from a third service request, the second service request being associated with at least one wireless device of a PLMN of an Network Exposure Function, NEF, that an AF provides information to when the at least one wireless device roams to other PLMNs, the third service request being associated with inbound roamer wireless devices from other PLMNs.

According to one or more embodiments of this aspect, the differentiating includes providing equipment route selection policy information that either: targets an inbound roamer from a PLMN ID; or targets an outbound roamer when the outbound roamer is roaming into a visited PLMN ID, the outbound roamer being at least one of a subscriber, a wireless device, a group of wireless devices, and any wireless device of a same PLMN of the NEF.

According to another aspect of the present disclosure, a network node is provided. Network node is configured to determine a user equipment route selection policy, URSP, for a wireless device based on whether the wireless device is an inbound roamer or an outbound roamer. Network node is configured to, when the wireless device is an inbound roamer: read service data using a first key, the first key being a wireless device public land mobile network, PLMN, identifier, ID; transmit first service parameters corresponding to the service data to a home policy control function, H-PCF. Network node is configured to, when the wireless device is an outbound roamer: read second service parameters using a second key, the second key being at least one of: a wireless device ID, a group ID of the wireless device, and any wireless device from a home UDR; and verify whether the second service parameters are applicable when the wireless device is roaming in a visited PLMN ID, VPLMNID.

According to one or more embodiments of this aspect, network node is further configured to: cause transmission of a request for guidance to a user data repository, UDR; and receive the guidance in response to the request.

According to one or more embodiments of this aspect, network node is further configured to: retrieve the first service parameters when a Subscriber Permanent Identifier, SUPI, of a public land mobile network, PLMN, one of registers or is available.

According to one or more embodiments of this aspect, network node is further configured to: one of query or subscribe the wireless device using a network identifier associated with the wireless device.

According to one or more embodiments of this aspect, the guidance is an Application Function, AF, guidance.

According to one or more embodiments of this aspect, the network identifier is a PLMN identifier, ID, that indicates a target of an Application Function, AF, request.

According to one or more embodiments of this aspect, the network node includes a Policy Control Function, PCF.

According to one or more embodiments of this aspect, the wireless device is registered with the network.

According to another aspect of the present disclosure, a method implemented by a network node is provided. The method includes: determining a user equipment route selection policy, URSP, for a wireless device based on whether the wireless device is an inbound roamer or an outbound roamer. The method includes, when the wireless device is an inbound roamer: reading service data using a first key, the first key being a wireless device public land mobile network, PLMN, identifier, ID; transmitting first service parameters corresponding to the service data to a home policy control function, H-PCF. The method includes, when the wireless device is an outbound roamer: reading second service parameters using a second key, the second key being at least one of: a wireless device ID, a group ID of the wireless device, and any wireless device from a home UDR; and verifying whether the second service parameters are applicable when the wireless device is roaming in a visited PLMN ID, VPLMNID.

According to one or more embodiments of this aspect, the method further includes: causing transmission of a request for guidance to a user data repository, UDR; and receiving the guidance in response to the request.

According to one or more embodiments of this aspect, the method further includes retrieving the first service parameters when a Subscriber Permanent Identifier, SUPI, of a public land mobile network, PLMN, one of registers or is available.

According to one or more embodiments of this aspect, the method further includes one of querying or subscribing the wireless device using a network identifier associated with the wireless device.

According to one or more embodiments of this aspect, the guidance is an Application Function, AF, guidance.

According to one or more embodiments of this aspect, the network identifier is a PLMN identifier, ID, that indicates a target of an Application Function, AF, request.

According to one or more embodiments of this aspect, the network node includes a Policy Control Function, PCF.

According to one or more embodiments of this aspect, the wireless device is registered with the network.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of another example process in a network node according to some embodiments of the present disclosure;

FIG. 9 is a flowchart of another example process in a network node according to some embodiments of the present disclosure;

FIG. 10 is a diagram of service specific information provisioning according to some embodiments of the present disclosure; and

FIG. 11 is a diagram of a UE Policy Association Establishment according to some embodiments of the present disclosure.

### DETAILED DESCRIPTION

Before describing in detail example embodiments, it is noted that the embodiments reside primarily in combinations of apparatus components and processing steps related to an network node (e.g., AF) providing rules such as URSP rules for one or more devices and/or nodes such as roamer wireless devices Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), PCF (e.g., V-PCF, H-PCF), AF (e.g., V-AF, H-AF), NEF (e.g., V-NEF, H-NEF), UDR (e.g., V-UDR, H-UDR), any other core network node, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

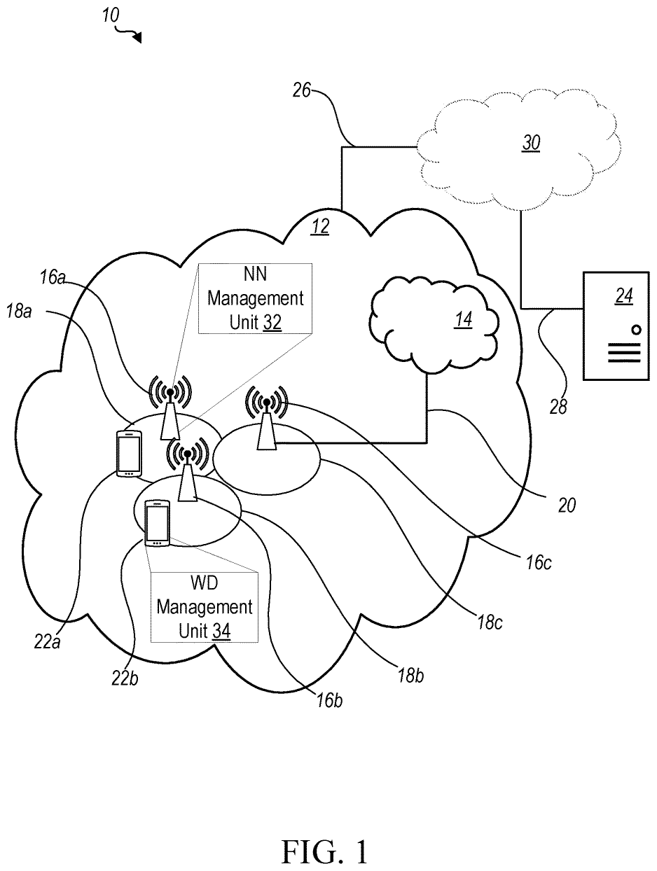

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., determine a request a request for guidance on a rule determination associated with WD roaming. A wireless device 22 is configured to include a WD management unit 34 which is configured to perform any step and/or task and/or process and/or method and/or feature described in the present disclosure.

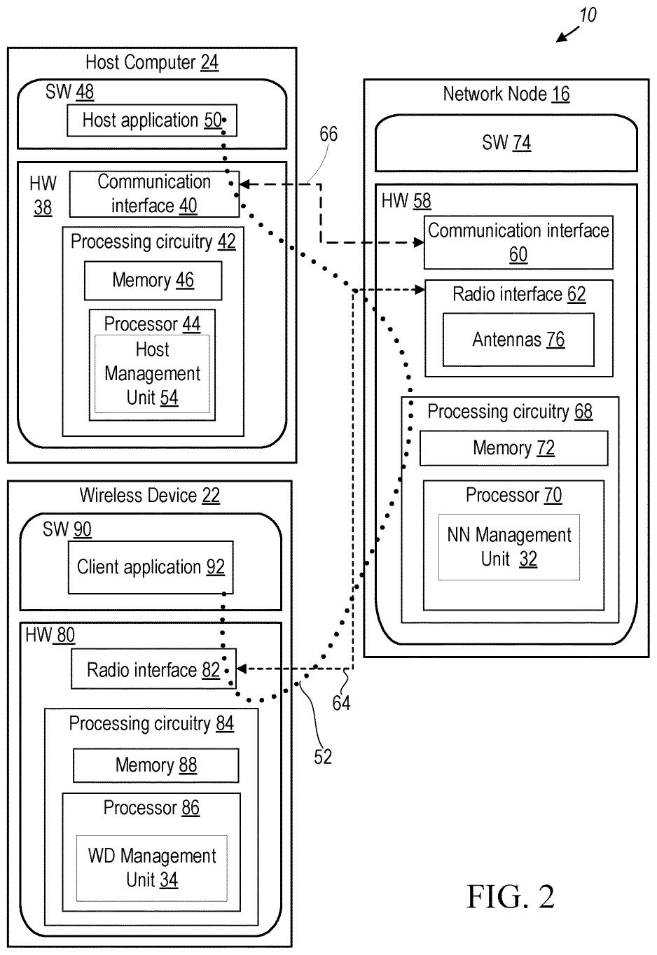

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN management unit 32 which is configured to perform any step and/or task and/or process and/or method and/or feature described in the present disclosure, e.g., determine a request a request for guidance on a rule determination associated with WD roaming.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may a WD management unit 34 which is configured to perform any step and/or task and/or process and/or method and/or feature described in the present disclosure.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

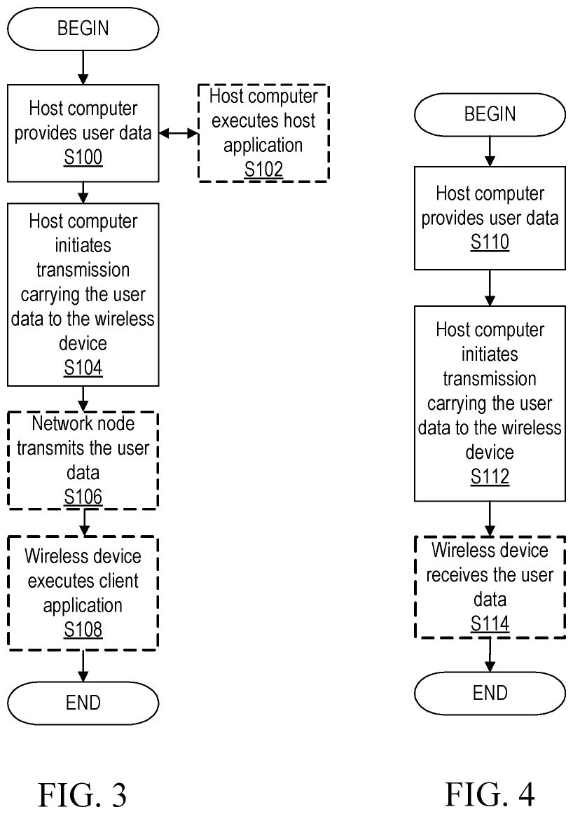

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

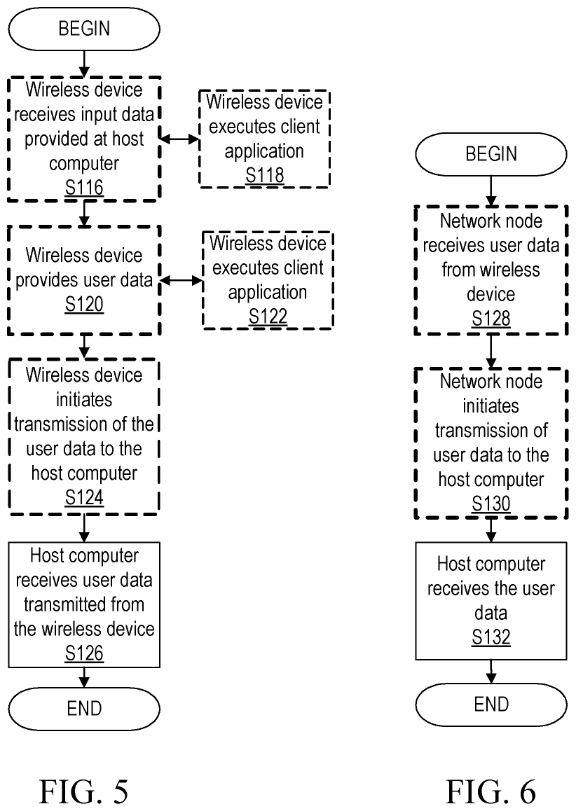

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

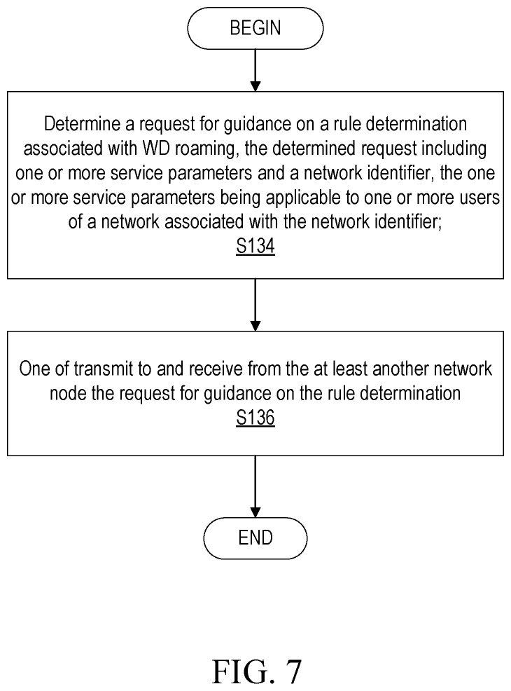

FIG. 7 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) a request for guidance on a rule determination associated with WD roaming, where the determined request includes one or more service parameters and a network identifier, and the one or more service parameters are applicable to one or more users of a network associated with the network identifier; and one of (Block S136) transmitting to and receiving from the at least another network node the request for guidance on the rule determination.

In some embodiments, one or more of: the guidance is an Application Function (AF) guidance; the rule determination is a user equipment route selection policy (URSP) rule determination; the network is a public land mobile network (PLMN); the network identifier is a PLMN identifier (ID) of a network element function (NEF) that receives information from an AF; the network node 16 comprises the AF; and the WD 22 is registered with the network 12, 14.

In some other embodiments, the method further includes determining a first service request including one or both of a target WD 22 set to inbound roamer of one or more PLMN IDs and the one or more PLMN IDs of inbound roamer PLMNs associated with the guidance on rule determination.

In some embodiments, the method further includes differentiating a second service request from a third service request. The second request is associated with any user of a PLMN of an NEF that an AF provides information when the WD 22 roams to other PLMNs, the third service request being associated with inbound roamer WDs 22 from other PLMNs.

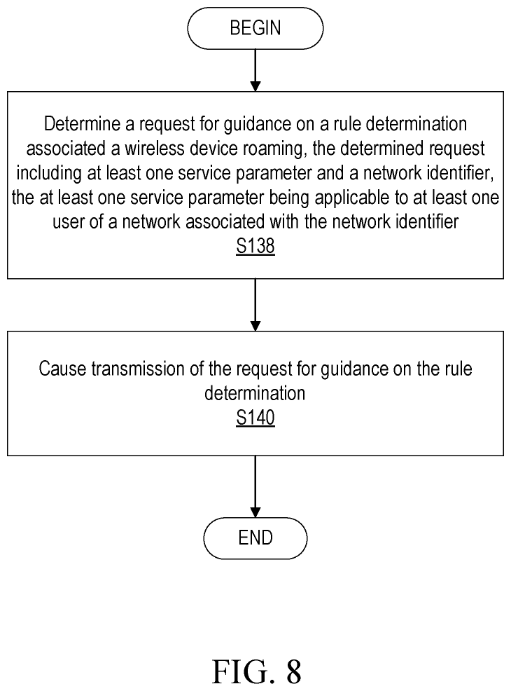

FIG. 8 is another flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to determine (Block S138) a request for guidance on a rule determination associated a wireless device roaming, the determined request including at least one service parameter and a network identifier, the at least one service parameter being applicable to at least one user of a network associated with the network identifier. Network node 16 is configured to cause (Block S140) transmission of the request for guidance on the rule determination.

In some embodiments, the guidance is an Application Function, AF, guidance.

In some embodiments, the rule determination is a user equipment route selection policy, URSP, rule determination.

In some embodiments, the network is a public land mobile network, PLMN.

In some embodiments, the network identifier is a public land mobile network, PLMN identifier, ID, of an inbound roamer.

In some embodiments, the network identifier is a visiting public land mobile network, VPLMN identifier, ID, of where the at least one service parameter applies.

In some embodiments, the request further comprises at least one of: a wireless device identifier, a group identifier, and a wireless device indication corresponding to any wireless device.

In some embodiments, the network node comprises the AF.

In some embodiments, the wireless device is registered with the network.

In some embodiments, the network node 16 is further configured to determine a first service request including one or both of a target wireless device set to inbound roamer of at least one Public Land Mobile Network, PLMN, ID and at least one PLMN ID of inbound roamer PLMNs associated with the guidance on rule determination.

In some embodiments, the network node 16 is further configured to differentiate a second service request from a third service request, the second service request being associated with at least one wireless device of a PLMN of an Network Exposure Function, NEF, that an AF provides information to when the at least one wireless device roams to other PLMNs, the third service request being associated with inbound roamer wireless devices from other PLMNs.

In some embodiments, the differentiating includes providing equipment route selection policy information that either: targets an inbound roamer from a PLMN ID; or targets an outbound roamer when the outbound roamer is roaming into a visited PLMN ID, the outbound roamer being at least one of a subscriber, a wireless device, a group of wireless devices, and any wireless device of a same PLMN of the NEF.

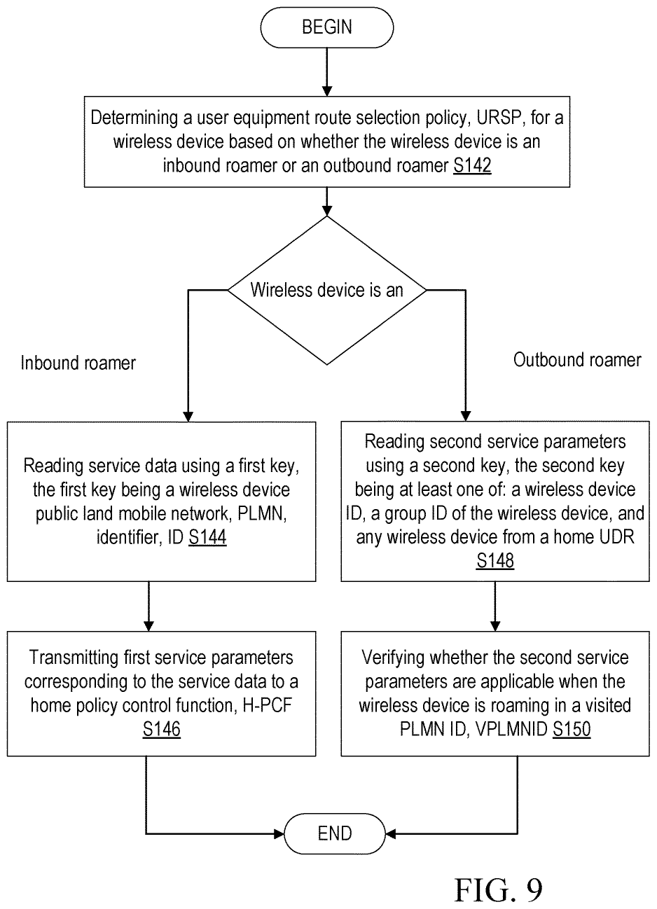

FIG. 9 is another flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to determine (Block S142) a user equipment route selection policy, URSP, for a wireless device based on whether the wireless device is an inbound roamer or an outbound roamer. Network node 16 is configured to, when the wireless device is an inbound roamer: read (Block S144) service data using a first key, the first key being a wireless device public land mobile network, PLMN, identifier, ID; transmit (Block S146) first service parameters corresponding to the service data to a home policy control function, H-PCF. Network node 16 is configured to, when the wireless device is an outbound roamer: read (Block S148) second service parameters using a second key, the second key being at least one of: a wireless device ID, a group ID of the wireless device, and any wireless device from a home UDR; and verify (Block S150) whether the second service parameters are applicable when the wireless device is roaming in a visited PLMN ID, VPLMNID.

In some embodiments, network node 16 is further configured to: cause transmission of a request for guidance to a user data repository, UDR; and receive the guidance in response to the request.

In some embodiments, network node 16 is further configured to: retrieve the first service parameters when a Subscriber Permanent Identifier, SUPI, of a public land mobile network, PLMN, one of registers or is available.

In some embodiments, network node 16 is further configured to: one of query or subscribe the wireless device using a network identifier associated with the wireless device.

In some embodiments, the guidance is an Application Function, AF, guidance.

In some embodiments, the network identifier is a PLMN identifier, ID, that indicates a target of an Application Function, AF, request.

In some embodiments, the network node 16 comprises a Policy Control Function, PCF.

In some embodiments, the wireless device 22 is registered with the network.

Having described the general process flow of arrangements of the disclosure and having provided examples of hardware and software arrangements for implementing the processes and functions of the disclosure, the sections below provide details and examples of arrangements for a network node 16 (e.g., AF) to provide rules such as URSP rules for one or more devices and/or nodes such as roamer wireless devices 22.

In some embodiments, for service parameter requests that are associated to inbound roamer WDs 22 from other PLMNs, an input in NEF Service operation may be determined and/or provided by NN 16 (e.g., Nnef_ServiceParameter_Create, Nnef_ServiceParameter_Update, Nnef_ServiceParameter_Delete and Nnef_ServiceParameter_Get, etc.)

In some other embodiments, the input may be one or both of:
1) a target WD identifier (e.g., new target UE identifier) set to “any inbound roamers of PLMN ID(s)” and the PLMN ID(s) of the inbound roamers PLMNs, that the AF guidance on URSP rule determination information is associated to. The PLMN ID(s) of the inbound roamers PLMNs may be indicated either: as part of the service parameters; and/or as a separate information element within the request.
2) a target WD identifier (e.g., new target UE identifier) set to the PLMN ID(s) of the inbound roamers PLMNs, that the service parameters are associated to.

In some embodiments, a service definition can be updated as follows.

Nnef_ServiceParameter_Create operation

Service operation name: Nnef_ServiceParameter_Create

Description: The consumer stores service specific parameters in the UDR via the NEF.

Inputs, (which may be required): Service Descriptor (e.g. the combination of data network name (DNN) and single network slice selection assistance information (S-NSSAI), an AF-Service-Identifier or an External Application Identifier).

Inputs, (which may be optional): Service Parameters and Target UE identifiers (e.g. the address (IP or Ethernet) of the WD 22 (e.g., UE) if available, GPSI if available, External Group Identifier if available, any inbound roamers of PLMN ID(s)/PLMN ID(s) of inbound roamers the service parameters are related to), subscribedEvents, notificationDestination. When the service parameter request is associated to inbound roamers of other PLMNs, the PLMN ID(s) of the inbound roamers maybe:
Option 1.a) included within the service parameters as a new IE e.g. “inbound roamer PLMN ID(s)” or
Option 1.b) also included as input (at same level as Target WD 22 (Target UE) identifiers).

If the PLMN ID of the inbound roamer is not included, then the service parameters apply to any inbound roamer from any PLMN.

If identifiers of Target WD(s) 22 (Target UE(s)) or a group of WDs 22 (UEs) or any inbound roamers of PLMN ID(s) are not provided, then the Service Parameters shall correspond to any WDs 22 (Ues) of the PLMN of the NEF using the service identified by the Service Description.

Outputs, (which may be required): Transaction Reference ID, operation execution result indication.

Outputs, (which may be optional): None.

### Nnef_ServiceParameter_Update Operation

Service operation name: Nnef_ServiceParameter_Update

Description: The consumer updates service specific parameters in the UDR via the NEF.

Inputs, (which may be required): Service Descriptor (e.g. the combination of DNN and S-NSSAI, an AF-Service-Identifier or an External Application Identifier), Transaction Reference ID.

Inputs, (which may be optional): Service Parameters and Target WD 22 (e.g., Target UE) identifiers (e.g. the address (IP or Ethernet) of the WD 22 (e.g., UE) if available, GPSI if available, External Group Identifier if available, or any inbound roamers of PLMN ID(s)/PLMN ID(s) of inbound roamers the service parameters are related to).

Outputs, (which may be required): Operation execution result indication.

Outputs, (which may be optional): None.

Nnef_ServiceParameter_Delete operation

Service operation name: Nnef_ServiceParameter_Delete

Description: The consumer deletes service specific parameters from the UDR via the NEF.

Inputs, (which may be required): Service Descriptor (e.g. the combination of DNN and S-NSSAI, an AF-Service-Identifier or an External Application Identifier), Transaction Reference ID.

Inputs, (which may be optional): Target WD 22 (e.g., target UE) identifiers (e.g. the address (IP or Ethernet) of the WD 22 (e.g., UE) if available, Generic Public Subscription Identifier (GPSI) if available, External Group Identifier if available or any inbound roamers of PLMN ID(s)/PLMN ID(s) of inbound roamers the service parameters are related to).

Outputs, (which may be required): Operation execution result indication.

Outputs, (which may be optional): None.

Nnef_ServiceParameter_Get operation

Service operation name: Nnef_ServiceParameter_Get

Description: The consumer retrieves service specific parameters in the UDR via the NEF.

Inputs, (which may be required): Service Descriptor (e.g. the combination of DNN and S-NSSAI, an AF-Service-Identifier or an External Application Identifier).

Inputs, (which may be optional): Service Parameters and Target WD 22 (e.g., target UE) identifiers (e.g. the address (IP or Ethernet) of the WD 22 (e.g., UE) if available, GPSI if available, External Group Identifier if available, or any inbound roamers of PLMN ID(s)/PLMN ID(s) of inbound roamers the service parameters are related to).

Outputs, (which may be required): Transaction Reference ID, operation execution result indication, requested data.

Outputs, (which may be optional): None.

In some embodiments, a NN 16 (e.g., V-PCF) retrieves the Service Parameters for inbound roamers at the time a Subscriber Permanent Identifier (SUPI) of a PLMN registers, if not already available. Then the NN 16 (e.g., V-PCF) uses Nudr_DM_Query or Nudr_DM_Subscribe including the Data Set “Application Data” and Data Subset “Service Parameters”, and Target WD 22 (e.g., target UE) set to either:
1. “any inbound roamers of PLMN ID(s)” indication. Additionally, the VPCF may indicate the PLMN ID of the inbound roamer WD 22 (e.g., UE) derived from the SUPI.
2. The PLMN ID of the inbound roamer WD 22 (e.g., UE) derived from the SUPI.

Another NN 16 (e.g., UDR) stores the Data Set Application Data, including a new Data Key set to “any inbound roamer of PLMN ID(s)” for Data Subset Service Parameters.

The following is an example of data keys.

TABLE 2
Example data keys

| | | | Data Sub |
|---|---|---|---|
| Data Set | Data Subset | Data Key | Key |
| Application | Packet Flow | Application Identifier | — |
| data | Descriptions (PFDs) | | |
| | AF traffic influence | AF transaction internal | |
| | request information | ID | |
| | (See clause 5.6.7 and | S-NSSAI and DNN | |
| | clause 6.3.7.2 of 3GPP | and/or | |
| | TS 23.501) | Internal Group Identifier | |
| | | or SUPI or “any UE” | |
| | | indication (NOTE 4) | |
| | Background Data | Internal Group Identifier | |
| | Transfer | or SUPI | |
| | (NOTE 3) | | |
| | Service specific | S-NSSAI and DNN | PLMN ID |
| | information (See | or | of inbound |
| | clause 4.15.6.7) | Internal Group Identifier | roamer's |
| | | or SUPI or “any UE” | SUPI. |
| | | indication (NOTE 4) or | |
| | | “any inbound roamer of | |
| | | PLMN ID(s)”/ PLMN | |
| | | ID of inbound roamer's | |
| | | SUPI (NOTE 6) | |
| | EAS Deployment | DNN and/or S-NSSAI | Application |
| | Information | | Identifier |
| | (See clause 7.1 of 3GPP | | and/or |
| | TS 23.548) | | Internal |
| | | | Group |
| | | | Identifier |
| | AM influence | AF transaction internal | |
| | information (See | ID | |
| | clause 4.15.6.9.3) | S-NSSAI and DNN | |
| | | and/or | |
| | | Internal Group Identifier | |
| | | or SUPI or “any UE” | |
| | | indication (NOTE 4) | |
| | Network Slice Specific | S-NSSAI | |
| | Control Data | | |
| | (See clause 6.2.1.3 of | | |
| | 3GPP TS 23.503) | | |
| | Operator Specific Data | SUPI or GPSI | |

NOTE 1: Retrieval of the stored Background Data Transfer References for all ASP identifiers in the UDR requires Data Subset but no Data Key or Data Subkey(s).

NOTE 2: Update of a Background Data Transfer Reference in the UDR requires a Data key to refer to a Background Data Transfer Reference as input data.

NOTE 3: The Background Data Transfer includes the Background Data Reference ID and the ASP Identifier that requests to apply the Background Data Reference ID to the WDs 22 (e.g., UE(s)). Furthermore, the Background Data Transfer includes the relevant information received from the AF, e.g., as defined in clause 6.1.2.4 of 3GPP TS 23.503.

NOTE 4: When the Data Key targets “any UE” (i.e., any WD 22), then the request to UDR applies on Application data that applies on all subscribers of the PLMN. For encoding, see 3GPP TS 29.519.

NOTE 5: Group Data includes 5G VN group configuration and any other data related to a group stored in the UDR.

NOTE 6: When the Data Key targets “any inbound roamer of PLMN ID(s)” then the request to UDR is on Application data for any WD 22 (e.g., UE) inbound roamer to the PLMN of the UDR. Additionally, the request may include the roaming's WD PLMN ID as a secondary key.

In some embodiments, for service parameter requests that are associated to a WD 22 (e.g., UE), a group of WDs 22 (e.g., Ues) or any WD 22 (e.g., UE) of the PLMN of the NEF, a NN 16 (e.g., AF) provides the information when the WDs 22 roam to other VPLMNs, the Service Parameters that the NN 16 (e.g., AF) provides (and are stored in the UDR) can include the VPLMN ID(s) that indicates the PLMN(s) where the AF guidance on URSP determination, and all its RSD(s), applies. The definition of service parameters (e.g. AF guidance for URSP determination) can be updated as follows.

### Service Parameters

Information on the AF guidance for URSP determination which may comprise a list of URSP rules that associate an application traffic descriptor with requested features for the candidate PDU sessions the application traffic may use:
An application traffic descriptor, having a definition that corresponds to that of the URSP Traffic Descriptors (e.g., as defined for the URSP rule in 3GPP TS 23.503 Table 6.6.2.1-2).
One or more sets of route selection parameters, each parameter may correspond to:
   (DNN, S-NSSAI). This may be provided by the NN 16 (e.g., AF) or determined by another NN 16 (e.g., NEF) based on the AF Identifier when it is not provided by the AF and the AF provides only one instance of AF guidance for URSP determination. In a nonlimiting example, the NN 16 (e.g., NEF) may provide Session and Service Continuity (SSC) mode.
A default route selection precedence value to be used for the application traffic when route selection precedence with a corresponding spatial validity condition is not provided.
Route selection precedence with a corresponding spatial validity condition that indicates where the route selection parameters apply. This may correspond to a geographical area (e.g., a civic address or shapes).
VPLMN ID(s) that indicates the PLMN(s) where the AF guidance on whether URSP determination, and all its RSD(s), applies.

The H-PCF uses this list of VPLMN ID(s) to provide the list of PLMN ID(s) where a URSP Rule(s) applies to the WD 22 (e.g., UE) when the WD Configuration update procedure is provisioned to the WD 22 (e.g., UE).

### EXAMPLE EMBODIMENTS

Example A1. A network node 16 configured to communicate with at least another network node 16 and/or a wireless device 22 (WD), the network node 16 configured to, and/or comprising a communication interface 60 and/or comprising processing circuitry 68 configured to one or both of:
determine a request for guidance on a rule determination associated with WD roaming, the determined request including one or more service parameters and a network identifier, the one or more service parameters being applicable to one or more users of a network associated with the network identifier; and
one of transmit to and receive from the at least another network node 16 the request for guidance on the rule determination.

Example A2. The network node 16 of Example A1, wherein one or more of: the guidance is an Application Function (AF) guidance; the rule determination is a user equipment route selection policy (URSP) rule determination; the network is a public land mobile network (PLMN); the network identifier is a PLMN identifier (ID) of a network element function (NEF) that receives information from an AF; the network node 16 comprises the AF; and the WD is registered with the network.

Example A3. The network node 16 of any one of Example A1 and A2, wherein the network node 16 is configured to: determine a first service request including one or both of a target WD set to inbound roamer of one or more PLMN IDs and the one or more PLMN IDs of inbound roamer PLMNs associated with the guidance on rule determination.

Example A4. The network node 16 of any one of Example A1-A3, wherein the network node 16 is configured to: differentiate a second service request from a third service request, the second request being associated with any user of a PLMN of an NEF that an AF provides information when the WD roams to other PLMNs, the third service request being associated with inbound roamer WDs from other PLMNs.

Example B1. A method implemented in a network node 16 configured to communicate with at least another network node 16 and/or a wireless device 22 (WD), the method comprising one or both of:
determining a request for guidance on a rule determination associated with WD roaming, the determined request including one or more service parameters and a network identifier, the one or more service parameters being applicable to one or more users of a network associated with the network identifier; and
one of transmitting to and receiving from the at least another network node 16 the request for guidance on the rule determination.

Example B2. The method of Example B1, wherein one or more of: the guidance is an Application Function (AF) guidance; the rule determination is a user equipment route selection policy (URSP) rule determination; the network is a public land mobile network (PLMN); the network identifier is a PLMN identifier (ID) of a network element function (NEF) that receives information from an AF; the network node 16 comprises the AF; and the WD is registered with the network.

Example B3. The method of any one of Example B1 and B2, wherein the method further includes: determining a first service request including one or both of a target WD set to inbound roamer of one or more PLMN IDs and the one or more PLMN IDs of inbound roamer PLMNs associated with the guidance on rule determination.

Example B4. The method of any one of Example B1-B3, wherein the method further includes: differentiating a second service request from a third service request, the second request being associated with any user of a PLMN of an NEF that an AF provides information when the WD roams to other PLMNs, the third service request being associated with inbound roamer WDs from other PLMNs.

In some embodiments, Service Parameters for URSP in VPLMN may be defined.

### 4.15.6.7 Service Specific Parameter Provisioning

This clause describes the procedures for enabling the AF to provide service specific parameters to 5G system via NEF.

The AF may issue requests on behalf of applications not owned by the PLMN serving the UE.

NOTE 1: In the case of architecture without CAPIF support, the AF is locally configured with the API termination points for the service. In the case of architecture with CAPIF support, the AF obtains the service API information from the CAPIF core function via the Availability of service APIs event notification or Service Discover Response as specified in 3GPP TS 23.222 version 18.0.0 dated 2022 Dec. 23, hereinafter “3GPP TS 23.222”.
The AF request sent to the NEF contains the information as below:
1)-Service Description.
   Service Description is the information to identify a service the Service Parameters are applied to. The Service Description in the AF request can be represented by the combination of DNN and S-NSSAI, an AF-Service-Identifier or an External Application Identifier.
2) Service Parameters.
   Service Parameters are the service specific information which may need to be provisioned in the Network and delivered to the UE in order to support the service identified by the Service Description.
   VPLMN ID(s) that indicates the PLMN(s) where the AF guidance on URSP determination, and all its RSD(s), applies.
3) Target UE(s) or a group of UEs or PLMN ID(s) of inbound roamers.
   Target UE(s) or a group of UEs or PLMN ID(s) of inbound roamers indicate the UE(s) who the Service Parameters shall be delivered to. Individual UEs can be identified by GPSI, or an IP address/Prefix or a MAC address. Groups of UEs are identified by an External Group Identifiers as defined in 3GPP TS 23.682 version 17.3.0 dated 2022 Jun. 15, hereinafter “3GPP TS 23.682”. If identifiers of target UE(s) or a group of UEs or PLMN ID(s) of inbound roamers are not provided, then the Service Parameters shall be delivered to any UEs of the PLMN of the NEF using the service identified by the Service Description.
4) Subscription to events.
   The AF may subscribe to notifications about the outcome of the UE Policies delivery due to service specific parameter provisioning.

The NEF authorizes the AF request received from the AF and stores the information in the UDR as “Application Data”. The Service Parameters are delivered to the targeted UE by the PCF when the UE is reachable.

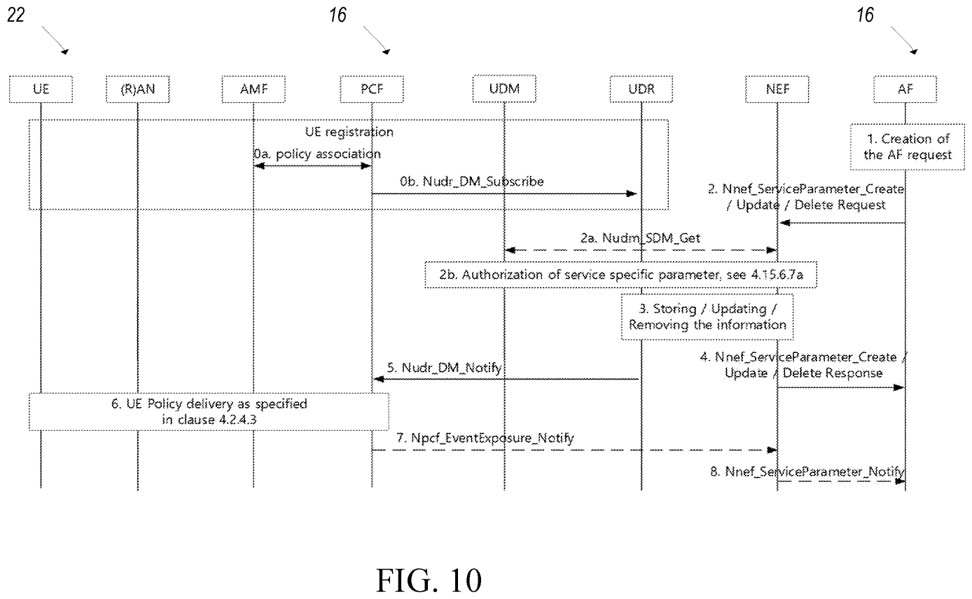

FIG. 10 shows procedure for service specific parameter provisioning. The AF uses Nnef_ServiceParameter service to provide the service specific parameters to the PLMN and the UE.
1. To create a new request, the AF invokes an Nnef_ServiceParameter_Create service operation. The request may include subscription information to the report of the outcome of UE Policy delivery.
   To update or remove an existing request, the AF invokes an Nnef_ServiceParameter_Update or Nnef_ServiceParameter_Delete service operation together with the corresponding Transaction Reference ID which was provided to the AF in Nnef_ServiceParameter_Create response message.
   The content of this service operation (AF request) includes the information described in clause 5.2.6.11.
2. The AF sends its request to the NEF. The NEF authorizes the AF request. The NEF performs the following mappings:
   Map the AF-Service-Identifier into DNN and S-NSSAI combination, determined by local configuration.
   Map the External Application Identifier into the corresponding Application Identifier known in the core network.
2a. The NEF may invoke Nudm_SDM_Get service operation to perform the following mappings:
   Map the GPSI in Target UE Identifier into SUPI, according to information received from UDM.
   Map the External Group Identifier in Target UE Identifier into Internal Group Identifier, according to information received from UDM.
If the AF subscribed to the outcome of UE Policy delivery, the AF indicates where the AF receives the corresponding notifications.
(in the case of Nnef_ServiceParameter_Create): The NEF assigns a Transaction

Reference ID to the Nnef_ServiceParameter_Create request.
2b. (in the case of Nnef_ServiceParameter_Create or Update): The NEF may need to authorize the service specific parameter provisioning request with the UDM by sending a Nudm_ServiceSpecificAuthorisation_Create service operation as defined in clause 4.15.6.7a.
NOTE 2: The NEF skips the mapping of GPSI or External Group Identifier in step 2a if it needs to authorize the service specific parameter provisioning request with the UDM as the response of the authorization request from UDM includes the SUPI or Internal Group Identifier.
   (in the case of Nnef_ServiceParameter_delete): The NEF requests the UDM to remove the authorization of the service specific parameters provisioned by sending a Nudm_ServiceSpecificAuthorisation_Remove service operation.
3. (in the case of Nnef_ServiceParameter_Create or Update): The NEF stores the AF request information in the UDR as the “Application Data” (Data Subset setting to “Service specific information”) together with the assigned Transaction Reference ID. (in the case of Nnef_ServiceParameter_delete): The NEF deletes the AF request information from the UDR.
4. The NEF responds to the AF. In the case of Nnef_ServiceParameter_Create response message, the response message includes the assigned Transaction Reference ID.

If the UE is registered to the network and the PCF performs the subscription to notification to the data modified in the UDR by invoking Nudr_DM_Subscribe (AF service parameter provisioning information, SUPI, Data Set setting to “Application Data”, Data Subset setting to “Service specific information”) at step 0, the following steps are performed:
5. The PCF(s) receive(s) a Nudr_DM_Notify notification of data change from the UDR.
NOTE 3: PCF does not have to subscribe for each UE the application specific information, e.g., if PCF has already received the application specific information for a group of UE or for a DNN by a subscription of other UE. The same application specific information is delivered to every UE in a group or a DNN.
6. The PCF initiates UE Policy delivery as specified in clause 4.2.4.3.
7. If the AF subscribed to notifications about the outcome of UE Policies delivery due to Service specific parameter provisioning targeting a single UE and the PCF is notified of UE Policy Container from the AMF, the PCF notifies the UE Policy delivery result contained in the UE Policy container as the outcome of the procedure to NEF by sending Npcf_EventExposure_Notify.
   If PCF is notified about UE Policy delivery failure from the AMF due to UE not reachable, the PCF may determine to retry step 6 of this procedure when the UE becomes reachable. In such a case, the PCF may report the interim status, i.e., UE is temporarily unreachable as the outcome of the procedure to NEF by sending Npcf_EventExposoure_Notify.
   If the PCF determines the failure of the UE Policies delivery procedure, the PCF notifies the failure with an appropriate cause such as UE is unreachable as the outcome of the procedure to NEF by sending Npcf_EventExposure_Notify. The content of event reporting in this step is described in clause 6.1.3.18 of 3GPP TS 23.503.
8. When the NEF receives Npcf_EventExposure_Notify, the NEF performs information mapping (e.g., AF Transaction Internal ID provided in Notification Correlation ID to AF Transaction ID, SUPI to GPSI, etc.) and triggers the appropriate Nnef_ServiceParameter_Notify message.

### 4.15.6.10 Application Guidance for URSP Determination

This clause describes the procedures to allow an AF to provide guidance for URSP determination to a 5G system via NEF. The AF may belong to the operator or to an external party. The PCF may be in the Home PLMN, as it is the PCF that determines the URSP for the UE, or in the VPLMN and then the Application guidance for URSP determination is provided to the PCF in the HPLMN via the PCF of the VPLMN. The PCF in the VPLMN translates the Service Parameters values provided by the AF for inbound roamer to values applicable to the HPLMN, e.g., S-NSSAI as described in 3GPP TS 23.503.
NOTE 1: The operator can negotiate with external party (typically a Corporate represented by an AF) dedicated DNN(s) and/or S-NSSAI(s) for the traffic of UE(s) of this external party. UE(s) of the external party can be identified by a group identifier.

The guidance for URSP determination may be used to provide 5GC with guidance for the URSPs depending on the UE location. This is further described in 3GPP TS 23.548.

For providing guidance for URSP determination, the procedure defined in clause 4.15.6.7 is performed with the following considerations:
1) Service Description indicates an AF Identifier.
2) Service Parameters.
   Information on the AF guidance for URSP determination which consists of a list of URSP rules that associate an application traffic descriptor with requested features for the candidate PDU sessions the application traffic may use:
      An application traffic descriptor, whose definition corresponds to that of the URSP Traffic Descriptors (as defined for the URSP rule in 3GPP TS 23.503 Table 6.6.2.1-2).
      one or more sets of Route selection parameters, each parameter may correspond to:
         (DNN, S-NSSAI). This may be provided by the AF or determined by the NEF based on the AF Identifier when it is not provided by the AF and the AF provides only one instance of AF guidance for URSP determination. Editor's note: It is FFS whether the AF can provide SSC mode.
      a default Route selection precedence value to be used for the application traffic when Route selection precedence with a corresponding spatial validity condition is not provided.
      Route selection precedence with a corresponding spatial validity condition that indicates where the Route selection parameters apply. This may correspond to a geographical area (e.g., a civic address or shapes).
      VPLMN ID(s) that indicates the PLMN(s) where the AF guidance on URSP determination, and all its RSD(s), applies.
NOTE 2: The different sets of Route selection parameters indicate different sets of PDU Session information (DNN, S-NSSAI) that can be associated with applications matching the application traffic descriptor. Each set is meant to apply for a specific (set of) spatial validity condition. Each set is associated with a Route selection precedence to cope with the case where multiple spatial validity conditions overlap.

If the AF provides a geographical area as spatial validity condition, it is up to the NEF to transform this information into 3GPP identifiers (e.g. TAI(s)). NEF may, based on local configuration, complement missing service parameters. Additionally, based on operator's local policy, NEF may request UDM for service specific authorization for the service parameters for an individual UE (e.g., to authorize the Corporate or MTC provider represented by the AF and the requested DNN, S-NSSAI for the related UE) before storing the service parameters into the UDR. If the request is targeting a group of UEs, NEF may also request UDM for service specific authorization for the group related data (see table 4.15.6.3b-1), i.e. the DNN, S-NSSAI associated to the group. If the request is targeting any UE (all UEs), NEF authorizes the request based on local policy (e.g., based on AF Id) without requesting for any service specific authorization from UDM. NEF requests UDM for service specific authorization for the service parameters provisioned via the Nudm_ServiceSpecificAuthorisation_Create service operation as defined in clause 4.15.6.7a.

If a group of UEs or any UE is requested, each individual UE authorization is performed at a later stage by PCF.
NOTE 3: The operator needs to ensure the consistency between the group related data and the UE group members subscription data, i.e., if a group is authorized for a given DNN/S-NSSAI as defined in the group related data, it needs to be ensured that all UE members of the group are provisioned with such DNN/S-NSSAI, since no individual UE check is required to be done by NEF against UDM.
NOTE 4: AF guidance for application traffic is not related with 5G VN group.
3) The Target UE identifier(s) that may be a specific UE, identified by a GPSI, or a group of UE(s), identified by an External-Group-ID, or any UE of the PLMN of the NEF, or the PLMN ID(s) of inbound roamers that the AF request may be associated with.
The information on the AF guidance for URSP determination provided by the AF may be associated to:
   a) UEs of the PLMN (of the NEF) when roaming in other PLMNs. In this case, the AF guidance for URSP determination targets to a specific UE, a group of UEs or any UE of the PLMN. In this case, the AF guidance for URSP determination associated to a specific UE, a group of UEs or any UE of the PLMN may be also associated with the corresponding VPLMN(s) where the AF guidance for URSP determination may be applied if the UE roams to that VPLMN(s). The list of VPLMN ID(s) is included in the Service Parameters.
   b) An inbound roamer from one or more PLMN(s). In this case, the AF targets the AF guidance for URSP determination only with the inbound roamers of corresponding PLMN(s). The PLMN ID is included in the Service Parameters.
NOTE X: Wildcarding of “PLMN ID of inbound roamers” will be handled by stage 3. Subscription to events.

The AF may subscribe to notifications about the outcome of the UE Policies delivery due to application guidance for URSP determination.

The usage of the AF guidance for application traffic is described in clause 6.2.4 in 3GPP TS 23.548.

### 4.16.11 UE Policy Association Establishment

This procedure concerns the following scenarios:
1. UE initial registration with the network.
2. The AMF relocation with PCF change in handover procedure and registration procedure.
3. UE registration with 5GS when the UE moves from EPS to 5GS and there is no existing UE Policy Association between AMF and PCF for this UE.

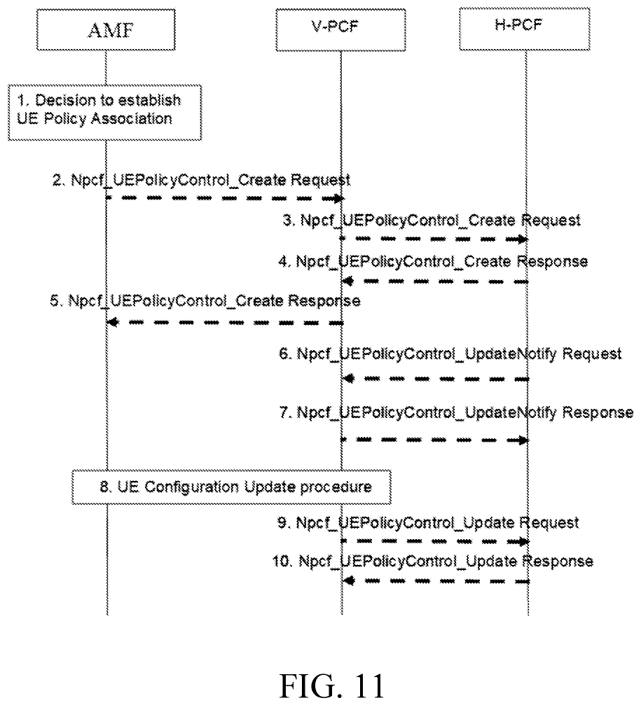

FIG. 11 is a diagram of a UE Policy Association Establishment.

This procedure concerns both roaming and non-roaming scenarios.

In the non-roaming case the V-PCF is not involved and the role of the H-PCF is performed by the PCF. For the roaming scenarios, the V-PCF interacts with the AMF and the H-PCF interacts with the V-PCF:
1. The AMF establishes UE Policy Association with the (V-)PCF when a UE Policy Container is received from the UE. If a UE Policy Container is not received from the UE, the AMF may establish UE Policy Association with the (V-)PCF based on AMF local configuration.
NOTE 1: In roaming scenario, the AMF local configuration can indicate whether UE Policy delivery is needed based on the roaming agreement with home PLMN of the UE.
2. The AMF sends a Npcf_UEPolicyControl Create Request with the following information: SUPI, may include Access Type and RAT, PEI, ULI, UE time zone, Serving Network (PLMN ID, or PLMN ID and NID, see clause 5.34 of 3GPP TS 23.501), the Internal-Group-ID-list and UE Policy Container (the list of stored PSIs, operating system identifier, Indication of UE support for ANDSP). In roaming scenario, based on operator policies, the AMF may provide to the V-PCF the PCF ID of the selected H-PCF. The V-PCF contacts the H-PCF. In roaming case, steps 3 and 4 are executed, otherwise step 5 follows.
   If the AMF, based on configuration, is aware that the UE is accessing over a gNB using GEO satellite backhaul, the AMF includes the Satellite Backhaul Category as described in clause 5.43.2 of 3GPP TS 23.501.
3. The V-PCF forwards the information received from AMF in step 2 to the H-PCF. When a UE Policy Container is received at initial registration, the H-PCF may store the PEI, the OSId or the indication of UE support for ANDSP in the UDR using Nudr_DM_Create including DataSet “Policy Data” and Data Subset “UE context policy control data”.
   The V-PCF may retrieve the Application guidance on URSP Rule for inbound roamers of the PLMN of the SUPI, if not available, using Nudr_DM_Query or Nudr_DM_Subscribe including the Data Set “Application Data” and Data Subset “Service Specific Information”, and DataKey set to “PLMN ID(s) of inbound roamers”
   The V-PCF may retrieve the Application guidance on URSP Rule for inbound roamers of the PLMN of the SUPI, if not available, using Nudr_DM_Query or Nudr_DM_Subscribe including the Data Set “Application
4. The H-PCF sends a Npcf_UEPolicyControl Create Response to the V-PCF. The H-PCF may provide the Policy Control Request Trigger parameters in the Npcf_UEPolicyControl Create Response.
   The (H-)PCF in roaming and the PCF in non-roaming may register to the BSF as the PCF serving this UE, if not already registered at the AM Policy Association establishment. This is performed by using the Nbsf_Management_Register operation, providing as inputs the UE SUPI/GPSI and the PCF identity.
5. The (V-) PCF sends a Npcf_UEPolicyControl Create Response to the AMF. The (V-)PCF relays the Policy Control Request Trigger parameters in the Npcf_UEPolicyControl Create Response.
   The (V-)PCF also subscribes to notification of N1 message delivery of policy information to the UE using Namf_Communication_N1N2MessageSubscribe service which is not shown in FIG. 11.
6. The (H-)PCF gets policy subscription related information and the latest list of PSIs from the UDR using Nudr_DM_Query service operation (SUPI, Policy Data, UE context policy control data, Policy Set Entry) if either or both are not available and makes a policy decision. The (H-)PCF may get the PEI, the OSId or the indication of UE support for ANDSP in the UDR using Nudr_DM_Query including DataSet “Policy Data” and Data Subset “UE context policy control data” if the AMF relocates and the PCF changes. In the roaming scenario, the H-PCF may provide the indication of UE support for ANDSP to the V-PCF, if the indication was not present in the Npcf_UEPolicyControl Create request from V-PCF and the H-PCF gets this information from the H-UDR. The (H-)PCF may get the 5G VN group data and 5G VN group membership for each Internal-Group-ID received from the AMF using Nudr_DM_Query (Internal-Group-Id, Subscription Data, 5G VN Group Configuration). The (H-)PCF may store the 5G VN group data and 5G VN group membership for later use for other SUPIs that belong to the same Internal-Group-ID. The (H-)PCF may request notifications from the UDR on changes in the subscription information by invoking Nudr_DM_Subscribe (Policy Data, SUPI, DNN, S-NSSAI, Notification Target Address (+Notification Correlation Id), Event Reporting Information (continuous reporting), UE context policy control data) service. The (H-)PCF may request notifications from the UDR on changes in the 5G VN group data or 5G VN group membership associated to each of the Internal-Group-Id provided to the PCF by invoking Nudr_DM_Subscribe (Subscription Data, 5G VN Group Configuration, Internal Group ID, Notification Target Address (+Notification Correlation Id), Event Reporting Information (continuous reporting)) service. The (H-)PCF creates the UE policy container including UE policy information as defined in clause 6.6 of 3GPP TS 23.503 and in the case of roaming H-PCF provides the UE policy container in the Npcf_UEPolicyControl UpdateNotify Request. In the non-roaming case, the PCF may subscribe to Analytics from NWDAF as defined in clause 6.1.1.3 of 3GPP TS 23.503.
7. The V-PCF sends a response to H-PCF using Npcf_UEPolicyControl UpdateNotify Response.
NOTE 2: Step 6 (and step 7) can be omitted. Then the (H-)PCF creates the UE policy container including UE polices in step 2 (in the case of non-roaming) or step 3 (in the case of roaming). This means that the potential interactions with UDR as in step 6 will have to be executed in step 2 (non-roaming) or step 3 (roaming).
8. The (V-)PCF triggers UE Configuration Update Procedure in clause 4.2.4.3 to send the UE policy container including UE policy information to the UE. The (V-)PCF checks the size limit as described in clause 6.1.2.2.2 of 3GPP TS 23.503.
9. If the V-PCF received notification of the reception of the UE Policy container then the V-PCF forwards the notification response of the UE to the H-PCF using Npcf_UEPolicyControl_Update Request.
   If the V-PCF is notified by the V-UDR about the Service Specific Information applicable to inbound roamers from the HPLMN of the UE as specified in clause 4.15.6.10, the V-PCF provides the Service Parameters to the H-PCF.
10. The H-PCF sends a response to the V-PCF. If the V-PCF received a UE Policy Container step 8 will follow.

### 5.2.12.2 Nudr_DataManagement (DM) Service

### 5.2.12.2.1 General

The operations defined for Nudr_DM service may use the following set of parameters defined in this clause:
Data Set Identifier: uniquely identifies the requested set of data within the UDR (see clause 4.2.5).
Data Subset Identifier: it uniquely identifies the data subset within each Data Set Identifier. As specified in the procedures in clause 4, e.g. subscription data can consist of subsets particularised for specific procedures like mobility, session, etc.
Data Keys defined in Table 5.2.12.2.1-1

For Nudr_DM_Subscribe and Nudr_DM_Notify operations:
The Target of Event Reporting is made up of a Data Key and possibly a Data Sub Key both defined in Table 5.2.12.2.1-1. When a Data Sub Key is defined in the table but not present in the Nudr_DM_Subscribe this means that all values of the Data Sub Key are targeted.
The Data Set Identifier plus (if present) the (set of) Data Subset Identifier(s) corresponds to a (set of) Event ID(s) as defined in clause 4.15.1

An NF Service Consumer may include an indicator when it invokes Nudr_DM Query/Create/Update service operation to subscribe the changes of the data, to avoid a separate Nudr_DM_Subscribe service operation.

Depending on the use case, it is possible to use a Data Key and/or one or multiple Data sub keys to further identify the corresponding data, as defined in Table 5.2.12.2.1-1 below.

Table 5.2.12.2.1-1: Data keys

| Data Set | Data Subset | Data Key | Data Sub Key |
|---|---|---|---|
| Subscription | Access and Mobility | SUPI | Serving PLMN |
| Data (see | Subscription data | | ID and |
| clause 5.2.3.3.1) | | | optionally NID |
| | SMF Selection | SUPI | Serving PLMN |
| | Subscription data | | ID and |
| | | | optionally NID |
| | UE context in SMF data | SUPI | PDU Session |
| | | | ID or DNN |
| | SMS Management | SUPI | Serving PLMN |
| | Subscription data | | ID and |
| | | | optionally NID |
| | SMS Subscription data | SUPI | Serving PLMN |
| | | | ID and |
| | | | optionally NID |
| | Session Management | SUPI | S-NSSAI |
| | Subscription data | | DNN |
| | | | Serving PLMN |
| | | | ID and |
| | | | optionally NID |
| | Slice Selection | SUPI | Serving PLMN |
| | Subscription data | | ID and |
| | | | optionally NID |
| | Group Data | Internal | — |
| | (NOTE 5) | Group | |
| | | Identifier or | |
| | | External | |
| | | Group | |
| | | Identifier | |
| | Identifier translation | GPSI | |
| | | SUPI | Application |
| | | | Port ID, MTC |
| | | | Provider |
| | | | Information, AF |
| | | | Identifier |
| | Intersystem continuity | SUPI | DNN |
| | Context | | |
| | LCS privacy | SUPI | — |
| | LCS mobile origination | SUPI | — |
| | UE reachability | SUPI | — |
| | Group Identifier | Internal | — |
| | Translation | Group | |
| | | Identifier or | |
| | | External | |
| | | Group | |
| | | Identifier | |
| | UE context in SMSF data | SUPI | — |
| | V2X Subscription data | SUPI | — |
| | ProSe Subscription data | SUPI | — |
| | User consent | SUPI | Purpose |
| | ECS Address | SUPI, | DNN, S-NSSAI |
| | Configuration Information | Internal | |
| | (See Table 4.15.6.3d-1) | group | |
| | | identifier or | |
| | | external | |
| | | group | |
| | | identifier or | |
| | | any UE | |
| | MBS Subscription data | SUPI | — |
| | Shared data | Shared Data | — |
| | | ID | |
| Application data | Packet Flow Descriptions | Application | — |
| | (PFDs) | Identifier | |
| | AF traffic influence | AF | |
| | request information | transaction | |
| | (See clause 5.6.7 and | internal ID | |
| | clause 6.3.7.2 of 3GPP | S-NSSAI | |
| | TS 23.501) | and DNN | |
| | | and/or | |
| | | Internal | |
| | | Group | |
| | | Identifier or | |
| | | SUPI or “any | |
| | | UE” | |
| | | indication | |
| | | (NOTE 4) | |
| | Background Data Transfer | Internal | |
| | (NOTE 3) | Group | |
| | | Identifier or | |
| | | SUPI | |
| | Service specific | S-NSSAI | |
| | information (See | and DNN | |
| | clause 4.15.6.7) | or | |
| | | Internal | |
| | | Group | |
| | | Identifier or | |
| | | SUPI or “any | |
| | | UE” | |
| | | indication | |
| | | (NOTE 4) or | |
| | | “PLMN | |
| | | ID(s) of | |
| | | inbound | |
| | | roamer” | |
| | EAS Deployment | DNN and/or | Application |
| | Information | S-NSSAI | Identifier and/or |
| | (See clause 7.1 of 3GPP | | Internal Group |
| | TS 23.548) | | Identifier |
| | AM influence information | AF | |
| | (See clause 4.15.6.9.3) | transaction | |
| | | internal ID | |
| | | S-NSSAI | |
| | | and DNN | |
| | | and/or | |
| | | Internal | |
| | | Group | |
| | | Identifier or | |
| | | SUPI or “any | |
| | | UE” | |
| | | indication | |
| | | (NOTE 4) | |
| Policy Data | UE context policy control | SUPI | |
| | data | | |
| | (See clause 6.2.1.3 of | | |
| | 3GPP TS 23.503) | | |
| | PDU Session policy | SUPI | S-NSSAI |
| | control data | | DNN |
| | (See clause 6.2.1.3 of | | |
| | 3GPP TS 23.503) | | |
| | Policy Set Entry data | SUPI (for | |
| | (See clause 6.2.1.3 of | the UDR in | |
| | 3GPP TS 23.503) | HPLMN) | |
| | | PLMN ID | |
| | | (for the UDR | |
| | | in VPLMN) | |
| | Remaining allowed Usage | SUPI | S-NSSAI |
| | data | | DNN |
| | (See clause 6.2.1.3 of | | |
| | 3GPP TS 23.503) | | |
| | Sponsored data | Sponsor | |
| | connectivity profiles (See | Identity | |
| | clause 6.2.1.6 of 3GPP | | |
| | TS 23.503) | | |
| | Background Data Transfer | Background | |
| | data | Data | |
| | (See clause 6.2.1.6 of | Transfer | |
| | 3GPP TS 23.503) | Reference | |
| | | ID. | |
| | | (NOTE 2) | |
| | | None. | |
| | | (NOTE 1) | |
| | Network Slice Specific | S-NSSAI | |
| | Control Data | | |
| | (See clause 6.2.1.3 of | | |
| | 3GPP TS 23.503) | | |
| | Operator Specific Data | SUPI or | |
| | | GPSI | |
| Exposure Data | Access and Mobility | SUPI or | PDU Session |
| (see | Information | GPSI | ID or |
| clause 5.2.12.1) | Session Management | SUPI or | UE IP address |
| | information | GPSI | or DNN |

NOTE 1:
Retrieval of the stored Background Data Transfer References for all ASP identifiers in the UDR requires Data Subset but no Data Key or Data Subkey(s).
NOTE 2:
Update of a Background Data Transfer Reference in the UDR requires a Data key to refer to a Background Data Transfer Reference as input data.
NOTE 3:
The Background Data Transfer includes the Background Data Reference ID and the ASP Identifier that requests to apply the Background Data Reference ID to the UE(s). Furthermore, the Background Data Transfer
includes the relevant information received from the AF as defined in clause 6.1.2.4 of 3GPP TS 23.503.
NOTE 4:
When the Data Key targets “any UE”, then the request to UDR applies on Application data that applies on all subscribers of the PLMN. For encoding, see 3GPP TS 29.519.
NOTE 5:
Group Data includes 5G VN group configuration and any other data related to a group stored in the UDR.

The content of the UDR storage for (Data Set Id=Application Data, Data Subset Id=AF TrafficInfluence request information) is specified in clause 5.6.7, Table 5.6.7-1 of 3GPP TS 23.501. This information is written by the NEF and read by the PCF(s). PCF(s) may also subscribe to changes onto this information.

5.2.6.11.2 Nnef_ServiceParameter_Create operation

Service operation name: Nnef_ServiceParameter_Create

Description: The consumer stores service specific parameters in the UDR via the NEF.

Inputs, Required: Service Descriptor (e.g. the combination of DNN and S-NSSAI, an AF-Service-Identifier or an External Application Identifier)

Inputs, Optional: Service Parameters and Target UE identifiers (e.g. the address (IP or Ethernet) of the UE if available, GPSI if available, External Group Identifier if available, “PLMN ID(s) of inbound roamers”, subscribedEvents, notificationDestination.

If identifiers of target UE(s) or a group of UEs or “PLMN ID(s) of inbound roamers” are not provided, then the Service Parameters shall correspond to any UEs of the PLMN of the NEF using the service identified by the Service Description.

Outputs, Required: Transaction Reference ID, operation execution result indication.

Outputs, Optional: None.

5.2.6.11.3 Nnef_ServiceParameter_Update operation

Service operation name: Nnef_ServiceParameter_Update

Description: The consumer updates service specific parameters in the UDR via the NEF.

Inputs, Required: Service Descriptor (e.g., the combination of DNN and S-NSSAI, an AF-Service-Identifier or an External Application Identifier), Transaction Reference ID.

Inputs, Optional: Service Parameters and Target UE identifiers (e.g., the address (IP or Ethernet) of the UE if available, GPSI if available, External Group Identifier if available, or “PLMN ID(s) of inbound roamers”.

Outputs, Required: Operation execution result indication.

Outputs, Optional: None.

### 5.2.6.11.4 Nnef_ServiceParameter_Delete Operation

Service operation name: Nnef_ServiceParameter_Delete

Description: The consumer deletes service specific parameters from the UDR via the NEF.

Inputs, Required: Service Descriptor (e.g., the combination of DNN and S-NSSAI, an AF-Service-Identifier or an External Application Identifier), Transaction Reference ID.

Inputs, Optional: Target UE identifiers (e.g. the address (IP or Ethernet) of the UE if available, GPSI if available, External Group Identifier if available or “PLMN ID(s) of inbound roamers”.

Outputs, Required: Operation execution result indication.

Outputs, Optional: None.

### 5.2.6.11.5 Nnef_ServiceParameter_Get Operation

Service operation name: Nnef_ServiceParameter_Get

Description: The consumer retrieves service specific parameters in the UDR via the NEF.

Inputs, Required: Service Descriptor (e.g. the combination of DNN and S-NSSAI, an AF-Service-Identifier or an External Application Identifier).

Inputs, Optional: Service Parameters and Target UE identifiers (e.g. the address (IP or Ethernet) of the UE if available, GPSI if available, External Group Identifier if available, or “PLMN ID(s) of inbound roamers”.

Outputs, Required: Transaction Reference ID, operation execution result indication, requested data.

Outputs, Optional: None.

### 5.2.6.11.6 Nnef_ServiceParameter_Notify Operation

Service operation name: Nnef_ServiceParameter_Notify

Description: This service operation is used by the NEF to notify a Service Parameter Authorisation Update (e.g., to revoke an authorization) to AF. Forwards a notification event related to the invocation of Nnef_ServiceParameter service to the AF, e.g., the notification of outcome of UE Policies Delivery to AF.

Inputs, Required: Transaction Reference ID, GPSI, External Group Id, any UE, or “PLMN ID(s) of inbound roamers”, Event ID, Result.

The Transaction Reference ID identifies the AF request for service specific parameter provisioning that the event report is related to. The event ID may be the UE Policies delivery outcome defined in clause 4.15.6.7. The GPSI is the identifier of the UE for which the event report is related to.

Inputs, Optional: DNN, S-NSSAI, Event Information (defined on a per Event ID basis, for a UE Policies delivery outcome it may include the result of the UE Policies delivery procedure and for unsuccessful results, an identifier of the reason), authorization update information (e.g., authorization revocation cause).

Outputs, Required: None.

Outputs, Optional: None.

In some embodiments, provisions of URSP to route traffic to the VPLMN may be specified.

### 1.1 Some Example Definitions

Application detection filter: A logic used to detect packets generated by an application based on extended inspection of these packets, e.g., header and/or payload information, as well as dynamics of packet flows. The logic is entirely internal to a UPF.

Application identifier: An identifier referring to a specific application detection filter.

Application service provider: A business entity responsible for the application that is being/will be used by a UE, which may be either an AF operator or has an association with the AF operator.

Authorised QoS: The maximum QoS that is authorised for a service data flow. In the case of an aggregation of multiple service data flows within one QoS Flow, the combination of the “Authorised QoS” information of the individual service data flows is the “Authorised QoS” for the QoS Flow. It contains the 5QI and the data rate.

Binding: The association between a service data flow and the QoS Flow transporting that service data flow.

Binding mechanism: The method for creating, modifying and deleting bindings.

Charging control: The process of associating packets, belonging to a service data flow, to a charging key and applying online charging and/or offline charging, as appropriate.

Charging key: Information used by the CHF for rating purposes.

Detected application traffic: An aggregate set of packet flows that are generated by a given application and detected by an application detection filter.

Dynamic PCC Rule: a PCC rule, for which the definition is provided to the SMF by the PCF.

Gating control: The process of blocking or allowing packets, belonging to a service data flow/detected application's traffic, to pass through to the UPF.

Monitoring key: information used by the SMF and PCF for usage monitoring control purposes as a reference to a given set of service data flows or application (s), that all share a common allowed usage on a per UE and DNN basis.

Non-3GPP access network selection information: It consists of ePDG identifier configuration, N3IWF identification and non-3GPP access node selection information, as defined in 3GPP, e.g., clause 6.3.6.1 in 3GPP TS 23.501.

Non-Seamless Offload: A capability of the UE to access the data networks via non-3GPP access (e.g. WLAN radio access) outside of a PDU Session.

Operator-controlled service: A service for which complete PCC rule information, including service data flow filter information, is available in the PCF through configuration and/or dynamic interaction with an AF.

Operating System (OS): Collection of UE software that provides common services for applications.

Operating System Identifier (OSId): An identifier identifying the operating system.

OS specific Application Identifier (OSAppId): An identifier associated with a given application and uniquely identifying the application within the UE for a given operating system.

Packet flow: A specific user data flow from and/or to the UE.

Packet Flow Description (PFD): A set of information enabling the detection of application traffic provided by a 3rd party service provider.

PCC decision: A PCF decision for policy and charging control provided to the SMF (consisting of PCC rules and PDU Session related attributes), a PCF decision for access and mobility related control provided to the AMF, a PCF decision for UE policy information provided to the UE or a PCF decision for background data transfer policy provided to the AF.

PCC rule: A set of information enabling the detection of a service data flow and providing parameters for policy control and/or charging control and/or other control or support information. The possible information is described in clause 6.3.1.

Policy control: The process whereby the PCF indicates to the SMF how to control the QoS Flow. Policy control includes QoS control and/or gating control.

Policy Control Request trigger report: a notification, possibly containing additional information, of an event which occurs that corresponds with a Policy Control Request trigger.

Policy Control Request trigger: defines a condition when the SMF may interact again with the PCF.

Policy counter: A mechanism within the CHF to track spending applicable to a subscriber.

Policy counter identifier: A reference to a policy counter in the CHF for a subscriber.

Policy counter status: A label whose values are not standardized and that is associated with a policy counter's value relative to the spending limit(s) (the number of possible policy counter status values for a policy counter is one greater than the number of thresholds associated with that policy counter, i.e. policy counter status values describe the status around the thresholds). This is used to convey information relating to subscriber spending from CHF to PCF. Specific labels are configured jointly in CHF and PCF.

Policy Section: A Policy Section is identified by a Policy Section Identifier and consists of one or multiple URSP rule(s) or one or multiple WLANSP rule(s) or non-3GPP access network selection information or a combination of WLANSP rule(s) and non-3GPP access network selection information.

Predefined PCC Rule: a PCC rule that has been provisioned directly into the SMF by the operator.

Redirection: Redirect the detected service traffic to an application server (e.g., redirect to a top-up/service provisioning page).

Service data flow: An aggregate set of packet flows carried through the UPF that matches a service data flow template.

Service data flow filter: A set of packet flow header parameter values/ranges used to identify one or more of the packet flows in the UPF. The possible service data flow filters are defined in clause 6.2.2.2.

Service data flow filter identifier: A scalar that is unique for a specific service data flow (SDF) filter within a PDU Session.

Service data flow template: The set of service data flow filters in a PCC Rule or an application identifier in a PCC rule referring to an application detection filter in the SMF or in the UPF, required for defining a service data flow.

Service identifier: An identifier for a service. The service identifier provides the most detailed identification, specified for flow based charging, of a service data flow. A concrete instance of a service may be identified if additional AF information is available (further details to be found in clause 6.3.1).

Session based service: An end user service requiring application level signalling, which is separated from service rendering.

Spending limit: A spending limit is the usage limit of a policy counter (e.g., monetary, volume, duration) that a subscriber is allowed to consume.

Spending limit report: a notification, containing the current policy counter status generated from the CHF to the PCF.

Subscribed guaranteed bandwidth QoS: The per subscriber, authorized cumulative guaranteed bandwidth QoS which is provided by the UDR to the PCF.

Subscriber category: is a means to group the subscribers into different classes, e.g., gold user, silver user and bronze user.

UE Local Configuration: Information about the association of an application to either a PDU Session or to non-seamless Offload is configured in the Mobile Termination (MT) and in the Terminal Equipment (TE). For example, UE Local Configuration can include operator specific configuration (e.g., operator provided S-NSSAI(s)), or application specific parameters to set up a PDU Session or end user configuration for specific applications.

UE policy information: Policy information preconfigured in the UE and/or provisioned to the UE for access selection (i.e., ANDSP), PDU Session selection (i.e., URSP), V2X communications (i.e., V2XP) and/or ProSe operations (i.e., ProSeP).

Uplink binding verification: The network enforcement of terminal compliance with the negotiated uplink traffic mapping to QoS Flows.

User Preferences On Non-3GPP Access Selection: The list of configuration parameters provided by a layer (e.g., application) above NAS and used by the UE for access network discovery and selection.

VPLMN specific URSP Rules: A VPLMN specific URSP Rule is applicable when the UE is registered in the VPLMN and its equivalent PLMNs. VPLMN specific URSP rules are provided from the HPLMN and contains, based on agreements with VPLMN, HPLMN values for Network Slice Selection Policies and DNN Selection Policies. When provided, the Time and Location criteria in each of the RSD contain VPLMN values.

Editor's Note: The HPLMN value DNN selection is FFS.

### 1.1.1.1 6.6.2.2.x Provision of URSP to Route Traffic to the VPLMN

The H-PCF may provision VPLMN specific URSP Rules to UE for the purpose to route traffic to the VPLMN.

The H-PCF may use application guidance on URSP determination, received from the V-PCF or retrieved from UDR at the HPLMN, as input to generate new or update existing VPLMN specific URSP Rules, as well as other input data as described in clause 6.2.1.1.

The list of parameters provided for application guidance on URSP Rule determination is defined in clause 4.15.6.10 of 3GPP TS 23.502 version 18.0.0 dated 2022 Dec. 21, hereinafter “3GPP TS 23.502”.

The AF may provide application guidance on URSP Rule determination to the VPLMN or to the HPLMN.

When the AF provides application guidance on URSP Rule determination to the VPLMN, it will target “PLMN ID(s) of inbound roamers”, the NEF in the VPLMN authorizes requests based on local configuration using, e.g., the AF identifier before storing them in UDR, as defined in in clause 4.15.6.7 of 3GPP TS 23.502. The NEF in the VPLMN rejects any request for a GPSI or an External-Group-ID of a different PLMN. The UDR in the VPLMN notifies the V-PCF(s) that has subscribed to the reception of application guidance on URSP determination.

When the AF provides application guidance on URSP Rule determination to the HPLMN, it will target either a GPSI or an External-Group-ID or “any UE” of the HPLMN. The NEF in the HPLMN, may, based on the HPLMN operator local policy, authorize any request for a GPSI or an External-Group-ID and maps it into a SUPI or an Internal-Group-ID via UDM, before storing them in UDR as Application Data. The UDR notifies the H-PCF(s) that has subscribed to the reception of application guidance on URSP determination. The Application guidance on traffic routing may contain the VPLMN ID(s) where the Service Parameters apply.

When the UE Policy Association is established or the V-PCF receives updates on application guidance on URSP determination for a SUPI that has a UE Policy Association established, the V-PCF checks whether application guidance on URSP determination exists and applies for the SUPI then the V-PCF:
maps the S-NSSAI of the VPLMN into the S-NSSAI of the HPLMN, using the Configured NSSAI for the Serving PLMN provided by the AMF and stored in PCF and
subscribes to the result of the delivery of UE Policies if it was requested by the AF to the H-PCF, using the event reporting on “Notification on outcome of UE Policies delivery” described in clause 6.1.3.18.
Editor's Note: Whether and how the AMF sends the LBO information (i.e., S-NSSAI and DNN, received as the part of the SM selection data received from the UDM) to the V-PCF when establishing the UE Policy Association is FFS.
The H-PCF generates new or updated URSP Rules using the application guidance on URSP Rule determination where the VPLMN ID included in the Service Parameters is used to indicate to the UE that this URSP Rule applies when the UE is registered in the VPLMN ID. The H-PCF provides the list of PSIs applicable per VPLMN ID to the UE.
   Note: How to ensure that the enforcement of a VPLMN specific URSP rule sets up a PDU Session routing traffic to the VPLMN is FFS.
   Note: Whether and how URSP Rules can be wild-carded or how to include a group of V-PLMNs is FFS.

How the UE associates applications to PDU Sessions based on URSP Rules follows the same procedure as described in clause 6.6.2.3.

### 1.1.1.2 6.1.2.2.1 General

The 5GC may be able to provide policy information from the PCF to the UE. Such UE policy information includes:
1) Access Network Discovery & Selection Policy (ANDSP): It is used by the UE for selecting non-3GPP accesses and for selection of the N3IWF in the PLMN. The structure and the content of this policy are specified in clause 6.6.1.
2) UE Route Selection Policy (URSP): This policy is used by the UE to determine if a detected application can be associated to an established PDU Session, can be offloaded to non-3GPP access outside a PDU Session, can be routed via a ProSe Layer-3 UE-to-Network Relay outside a PDU session, or can trigger the establishment of a new PDU Session. The structure and the content of this policy are specified in clause 6.6.2. A URSP rule includes one Traffic descriptor that specifies the matching criteria and one or more of the following components:
   2a) SSC Mode Selection Policy (SSCMSP): This is used by the UE to associate the matching application with SSC modes.
   2b) Network Slice Selection Policy (NSSP): This is used by the UE to associate the matching application with S-NSSAI.
   2c) DNN Selection Policy: This is used by the UE to associate the matching application with DNN.
   2d) PDU Session Type Policy: This is used by the UE to associate the matching application with a PDU Session Type.
   2e) Non-Seamless Offload Policy: This is used by the UE to determine that the matching application should be non-seamlessly offloaded to non-3GPP access (i.e., outside of a PDU Session).
   2f) Access Type preference: If the UE needs to establish a PDU Session for the matching application, this indicates the preferred Access Type (3GPP or non-3GPP or Multi-Access).
NOTE 1: The Access Type of 3GPP also includes the use of ProSe UE-to-Network Relay access as defined in 3GPP, e.g., 3GPP TS 23.304 version 18.0.0 dated 2022 Dec. 21, hereinafter “3GPP TS 23.304”.
   2g) ProSe Layer-3 UE-to-Network Relay Offload Policy: This is used by the UE to determine if the matching application should be routed via a ProSe Layer-3 UE-to-Network Relay outside of a PDU Session. If this indication is not present the traffic may not be routed via a ProSe Layer-3 UE-to-Network Relay outside of a PDU Session.
   2h) PDU Session Pair ID: If the UE needs to establish a PDU Session for the matching application, this indicates PDU Sessions with same PDU Session Pair ID are paired for redundant transmission.
   2i) RSN: If the UE needs to establish a PDU Session for the matching application, this indicates RSN for redundant transmission.
3) V2X Policy (V2XP): This policy provides configuration parameters to the UE for V2X communication over PC5 reference point or over Uu reference point or both. V2X Policies are defined in clause 5.1.2.1 and clause 5.1.3.1 of 3GPP TS 23.287 version 17.5.0 dated 2022 Dec. 21, hereinafter “3GPP TS 23.287”.
4) ProSe Policy (ProSeP): This policy provides configuration parameters to the UE for ProSe Direct Discovery, ProSe Direct Communication, ProSe UE-to-Network Relay and Remote UE. ProSe Policies are defined in clauses 5.1.2.1, 5.1.3.1 and 5.1.4.1 of 3GPP TS 23.304.

The ANDSP and URSP may be pre-configured in the UE or may be provisioned to UE from PCF. The pre-configured policy may be applied by the UE only when it has not received the same type of policy from PCF.

The methods of configuring V2XP to the UE, including (pre-) configuration and provisioning, and the priority of the same type of parameters acquired from different sources are defined in clause 5.1.1 of 3GPP TS 23.287.

The methods of configuring ProSeP to the UE, including (pre-)configuration and provisioning, and the priority of the same type of parameters acquired from different sources are defined in clause 5.1.1 of 3GPP TS 23.304.

The PCF selects the UE policy information applicable for each UE based on local configuration, operator policies taking into consideration the information defined in clause 6.2.1.2, the PCF determines the URSP Rules for the UE using input from NWDAF as one of the inputs.

In the case of a roaming UE, the V-PCF may retrieve UE policy information from the H-PCF over N24/Npcf. When the UE is roaming and the UE has valid rules from both HPLMN and VPLMN the UE gives priority to the valid ANDSP rules from the VPLMN. In the case of a roaming UE, the V-PCF may provide guidance on VPLMN specific URSP determination to the H-PCF as defined in clause 4.15.6.10 of 3GPP TS 23.502. The H-PCF is required to generate VPLMN specific URSP rule(s) and provide the URSP rules to the UE. This can be triggered by the UE's registration in the VPLMN or it can happen before UE roams into the VPLMN. The URSP Rules received by UE in VPLMN are only applicable when the UE is registered in that VPLMN or its equivalent VPLMNs. The UE policy information shall be provided from the PCF to the AMF via N15/Namf interface and then from AMF to the UE via the N1 interface as described in clause 4.2.4.3 of 3GPP TS 23.502. The AMF may not change the UE policy information provided by PCF.

The PCF is responsible for delivery of UE policy. If the PCF is notified about UE policy information delivery failure (e.g., because of UE unreachable), the PCF may provide a new trigger “Connectivity state changes” in Policy Control Request Trigger of UE Policy Association to AMF as defined in clause 4.16.12.2 of 3GPP TS 23.502. After reception of the Notify message indicating that the UE enters the CM-Connected state, the PCF may retry to deliver the UE policy information.
NOTE 2: For backward compatibility the PCF may subscribe the “Connectivity state changes (IDLE or CONNECTED)” event in Rel-15 AMF as defined in clause 5.2.2.3 of 3GPP TS 23.502.

If due to UE Local Configurations, a UE application requests a network connection using Non-Seamless Offload or ProSe Layer-3 UE-to-Network Relay Offload, the UE shall use Non-Seamless Offload for this application without evaluating the URSP rules. Otherwise, the UE shall select the PDU Session or Non-Seamless Offload in the following order:
If the UE has an URSP rule (except the URSP rule with the “match all” Traffic descriptor) that matches the application as defined in clause 6.6.2.3, the UE may perform the association of the application to the corresponding PDU Session or to Non-Seamless Offload or ProSe Layer-3 UE-to-Network Relay Offload according to this rule;
If no URSP rule is applicable for the application (except the URSP rule with the “match all” Traffic descriptor), the UE may perform the association of the application to a PDU Session according to the applicable UE Local Configurations, if any. If the UE attempts to establish a new PDU Session according to the UE Local Configurations and this PDU Session Establishment request is rejected by the network, then the UE may perform the association of the application to a PDU Session or to Non-Seamless Offload or ProSe Layer-3 UE-to-Network Relay Offload according to the URSP rule with the “match all” Traffic descriptor;
NOTE 3: It is assumed that the S-NSSAI(s) in the UE Local Configurations are operator-provided S-NSSAI(s). The provision of the S-NSSAI(s) is not specified.
NOTE 4: The application layer is not allowed to set the S-NSSAI when the UE establishes a PDU Session based on the UE Local Configurations.
NOTE 5: Any missing information in the UE Local Configurations needed to build the PDU Session Establishment request can be the appropriate corresponding component from the URSP rule with the “match all” Traffic descriptor.
   If neither the UE Local Configurations nor the URSP rules are applicable for the application (except the URSP rule with the “match all” Traffic descriptor), the UE may perform the association of the application to a PDU Session or to Non-Seamless Offload or ProSe Layer-3 UE-to-Network Relay Offload according to the URSP rule with the “match all” Traffic descriptor.

For the existing PDU Session(s), the UE may examine the URSP rules within the UE policy information in order to determine whether the existing PDU Session(s) (if any) are maintained or not. If not, then the UE may initiate a PDU Session release procedure for the PDU Session(s) that cannot be maintained.

If there are multiple IPv6 prefixes within the PDU Session, then the IPv6 multi-homed routing rules, described in clause 5.8.2.2.2 in 3GPP TS 23.501, on the UE may be used to select which IPv6 prefix to route the traffic of the application.
NOTE 5: For the case that an application cannot be associated to any PDU Session, the UE can inform the application that association of the application to PDU Session fails.

The PCF may subscribe to analytics on “WLAN performance” from NWDAF following the procedures and services described in 3GPP TS 23.288 version 18.0.0 dated 2022 Dec. 21, hereinafter “3GPP TS 23.288”. When the PCF gets a notification from the NWDAF, the PCF may try to update WLANSP rules.

### 1.1.1.3 6.1.2.2.2 Distribution of the Policies to UE

The UE policy control enables the PCF to provide UE access selection related policy information, PDU Session related policy information and V2X Policy information to the UE, i.e., UE policies, that includes Access network discovery & selection policy (ANDSP) or UE Route Selection Policy (URSP) or V2X Policy (V2XP) or ProSe Policy (ProSeP) or their combinations using Npcf and Namf service operations.

The PCF may be triggered to provide the UE policy information during UE Policy Association Establishment and UE Policy Association Modification procedures as defined in clause 4.16.11 and clause 4.16.12 of 3GPP TS 23.502.
NOTE 1: The PCF can install a PCC Rule and activate start and stop of application detection in the SMF. When the same PCF is selected for SM policy association control and UE policy association control, the reporting of start and stop of an application can trigger the installation or update of a URSP rule in the UE to send the application traffic to the PDU Session as defined in the URSP rule.
NOTE 2: The PCF can subscribe to the UDR on service specific information change, which will be taken into consideration by the PCF to determine the updated V2XP and ProSeP as defined in clause 4.15.6.7 of 3GPP TS 23.502.
   Operator defined policies in the PCF may depend on input data such as UE location, time of day, information provided by other NFs, etc. as defined in clause 6.2.1.2.
   The PCF includes the UE policy information delivered to the UE into a Policy Section identified by a Policy Section Identifier (PSI). The PCF may divide the UE policy information into different Policy Sections, each one identified by a PSI. Each Policy Section provides a list of self-contained UE policy information to the UE, via AMF. The PCF ensures that a Policy Section is under a predefined size limit, known by the PCF.
NOTE 3: The size limit to allow the policy information to be delivered using NAS transport is specified in 3GPP TS 29.507 version 18.0.0 dated 2022 Dec. 16, hereinafter “3GPP TS 23.507”. The size limit is configured in the PCF.
   A list of self-contained UE policy information implies that:
when the PCF delivers URSP rules to the UE, the PCF provides the list of URSP rules in the order of precedence and without splitting a URSP rule across Policy Sections.
when the PCF delivers V2XP to the UE, the PCF provides the list of V2XP in the order of precedence and without splitting a V2XP across Policy Sections;
when the PCF delivers ProSeP to the UE, the PCF provides the list of ProSeP in the order of precedence and without splitting a ProSeP across Policy Sections;
when the PCF delivers WLANSP rules, the list of WLANSP rules are provided in the order of priority and without splitting a WLANSP rule across Policy Sections;
when the PCF delivers the non-3GPP access network selection information, the whole list of non-3GPP access network selection information (as defined in clause 6.6.1.1) is provided in one Policy Section.
   It is up to PCF to decide how to divide the UE policy information into Policy Sections as long as the requirements for the predefined size limit and the self-contained content (described above) are fulfilled.
NOTE 4: The Policy Section list can be different per user. One PSI and its corresponding content can be the same for one or more users.
NOTE 5: The PCF may, for example, assign the URSP as one whole Policy Section, or it may subdivide the information in the URSP into multiple Policy Sections by assigning one or several URSP rules to each Policy Section.

The PLMN ID is provided to the UE together with UE policy information and it is used to indicate which PLMN a Policy Section list belongs to.

The AMF forwards the UE policy information transparently to the UE. If the (H-)PCF decides to split the UE policies to be sent to the UE, the PCF provides multiple Policy Sections separately to the AMF and then AMF uses UE configuration Update procedure for transparent UE policies delivery procedure to deliver the policies to the UE, this is defined in clauses 4.2.4.3 and 4.16 of 3GPP TS 23.502.
NOTE 6: The AMF does not need to understand the content of the UE policy, rather send them to the UE for storage.

The UE may update the stored UE policy information with the one provided by the PCF as follows (details are specified in 3GPP TS 24.501):
If the UE has no Policy Sections with the same PSI, the UE stores the Policy Section;
If the UE has an existing Policy Section with the same PSI, the UE replaces the stored Policy Section with the received information;
The UE removes the stored Policy Section if the received information contains only the PSI.

The UE keeps the received UE policies stored even when registering in another PLMN.

The number of UE policies to be kept stored in the UE for PLMNs other than the HPLMN is up to UE implementation. If necessary, e.g., the number of UE policies stored in UE for PLMNs exceeds the maximum value, the UE may remove earlier stored UE policy in UE.
NOTE 7: For aspects related to URSP rules for an SNPN-enabled UE, please refer to clause 6.6.2.2.2.
   The ANDSP for VPLMN, if provided within the UE policy in the UE Configuration Update procedure described in clause 4.2.4.3 of 3GPP TS 23.502, applies to the equivalent PLMN(s) indicated in the last received list of equivalent PLMNs in Registration Accept.
   At Initial Registration or the Registration to 5GS when the UE moves from EPS to 5GS:
The UE provides the list of stored PSIs which identify the Policy Sections associated to the home PLMN and the visited PLMN (if the UE is roaming) that are currently stored in the UE. If USIM is changed, the UE does not provide any PSI. If no policies are stored in the UE for the home PLMN, the UE does not provide any PSI associated to the home PLMN. If the UE is roaming and has policies for the home PLMN but no associated policies for the visited PLMN the UE includes only the list of PSIs associated to the home PLMN.
UE may indicate its ANDSP support to the PCF. If it is received, the PCF may take it into account for the determination on whether to provide the ANDSP to the UE. The PCF does not provide ANDSP rules to the UE if the UE does not indicate support for ANDSP.
NOTE 8: In the roaming scenario, during AMF relocation with V-PCF change, if the H-PCF does not provide the Indication of UE support for ANDSP, then the behaviour of V-PCF to determine whether to provide ANDSP rules to the UE is implementation specific.
   UE may indicate the V2X Policy Provisioning Request in the UE Policy Container. If this indication is received, the PCF includes V2XP in the UE policy information as defined in clause 6.2.2 of 3GPP TS 23.287.
   UE may indicate the 5G ProSe Policy and Parameter Provisioning Request in the UE Policy Container. If this indication is received, the PCF includes ProSeP in the UE policy information as defined in clause 6.2.2 of 3GPP TS 23.304. PCF determines contents of ProSeP based on the information contained in the 5G ProSe Policy and Parameter Provisioning Request as defined in clause 4.3.1 of 3GPP TS 23.304.
   The UE may also provide the OSId.

The UE may trigger an Initial registration with the list of stored PSIs to request a synchronization for example if the UE powers up without USIM being changed.

During Initial Registration, the (H-)PCF retrieves the list of PSIs and its content stored in the (H-)UDR for this SUPI while the V-PCF (in the roaming scenario) retrieves the list of PSIs and its content stored in the V-UDR for the PLMN ID of this UE (alternatively, the V-PCF can have this information configured locally).
NOTE 9: The PSI list and content stored/configured for a PLMN ID can be structured according to, e.g., location areas (e.g., TAs, PRAs). The V-PCF can then provide PSIs and its content only if they correspond to the current UE location.

The PCF provides to the UE the tuple (PLMN ID, list of PSIs associated with the PLMN ID) and the Policy Sections containing URSP Rules. In roaming scenarios, the H-PCF provides this information via V-PCF.

In the roaming scenario, the V-PCF may also forward any UE provided PSIs that are associated to the home PLMN to the H-PCF.

When the PCF (i.e., the (H-)PCF as well as the V-PCF) receives a list of PSIs associated to the PLMN of the PCF from the UE, the PCF compares the list of PSIs provided by the UE and the list of PSIs retrieved from the UDR. In addition, the PCF checks whether the list of PSIs provided by the UE or its content needs to be updated according to operator policies, e.g., change of Location and/or time. If the two lists of PSIs are different or an update is necessary according to operator policies (which includes the case that the UE did not provide a list of PSIs associated to the PLMN of the PCF), the PCF provides the changes in the list of PSIs or the corresponding content to the AMF which forwards them to the UE.

The (H-)PCF maintains the latest list of PSIs delivered to each UE as part of the information related to the Policy Association until the UE policy association termination request is received from the AMF. Then the (H-)PCF stores the latest list of PSIs and its contents in the (H-)UDR using the Nudr_DM_Update including DataSet “Policy Data” and Data Subset “Policy Set Entry”.

The (H-)PCF may use the PEI provided by the AMF and/or the OSId provided by the UE, to determine the operating system of the UE.

If the PEI, the OSId or the indication of UE support for ANDSP is available to the (H-)PCF, the (H-)PCF stores them in the (H-)UDR using Nudr_DM_Create including DataSet “Policy Data” and Data Subset “UE context policy control data” when such information is received from the UE in the UE Policy Container.

If the (H-)PCF is not able to determine the operating system of the UE, and if the (H-)PCF requires to deliver URSP rules that contain Application descriptors as Traffic Descriptors, then the Traffic Descriptors of such URSP rules include multiple instances of Application descriptors each associated to supported UE operating systems by the network operator implementation.

If the (H-)PCF determines the operating system of the UE and if the (H-)PCF requires to deliver URSP rules that contain Application descriptors as Traffic Descriptors, then the Traffic Descriptors of such URSP rules include the Application descriptors associated with the operating system determined by the PCF.
NOTE 10: If the PCF does not take into account the received PEI and/or OSId then the PCF can send URSP rules containing application traffic descriptors associated to multiple operating systems.
   6.1.3.18 Event Reporting from the PCF

The AF may subscribe/unsubscribe to notifications of events from the PCF for the PDU Session to which the AF session is bound. The AF can either subscribe/unsubscribe directly at the PCF or indirectly via an NEF or a TSCTSF.

The PCF for the UE may subscribe/unsubscribe to notifications of events from the PCF for the PDU Session of a UE. Other NFs may subscribe/unsubscribe to notifications of events from the PCF for a PDU Session or for a UE.

The events that can be subscribed by the AF and by other NFs are listed in Table 6.1.3.18-1.

Table 6.1.3.18-1: Events relevant for reporting from the PCF is reproduced below.

| | | | Avail- | | Avail- | | | |
|---|---|---|---|---|---|---|---|---|
| | | | ability | Avail- | ability | Avail- | Avail- | Avail- |
| | | NF | for Rx | ability | for Bulk | ability | ability | ability |
| | | that can | PDU | for N5 | Subscrip- | for N43 | for N5 | for N24 |
| | | subscribe | Session | per | tion | per SUPI, | per UE | per UE |
| | | for | (NOTE | PDU | (NOTE | DNN, | (NOTE | (NOTE |
| Event | Description | reporting | 2) | Session | 1) | S-NSSAI | 6) | 6) |
| PLMN | The PLMN identifier | AF, | Yes | Yes | Yes | No | No | Yes |
| Identifier | or SNPN identifier | PCF | | | | | | |
| Notification | where the UE is | | | | | | | |
| (NOTE 5) | currently located. | | | | | | | |
| Change of | The Access Type and, | AF | Yes | Yes | Yes | No | No | No |
| Access | if applicable, the RAT | | | | | | | |
| Type | Type of the PDU | | | | | | | |
| | Session has changed. | | | | | | | |
| EPS | EPS fallback is | AF | Yes | Yes | No | No | No | No |
| fallback | initiated | | | | | | | |
| Signalling | The status of the | AF | Yes | Yes | No | No | No | No |
| path status | resources related to | | | | | | | |
| | the signalling traffic | | | | | | | |
| | of the AF session. | | | | | | | |
| Access | The Access Network | AF | Yes | Yes | No | No | No | No |
| Network | Charging Correlation | | | | | | | |
| Charging | Information of the | | | | | | | |
| Correlation | resources allocated | | | | | | | |
| Information | for the AF session. | | | | | | | |
| Access | The user location | AF | Yes | Yes | No | No | No | No |
| Network | and/or timezone when | | | | | | | |
| Information | the PDU Session has | | | | | | | |
| Notification | changed in relation to | | | | | | | |
| | the AF session. | | | | | | | |
| Reporting | The usage threshold | AF | Yes | Yes | No | No | No | No |
| Usage for | provided by the AF | | | | | | | |
| Sponsored | has been reached; or | | | | | | | |
| Data | the AF session is | | | | | | | |
| Connectivity | terminated. | | | | | | | |
| Service | The resources related | AF | Yes | Yes | No | No | No | No |
| Data Flow | to the AF session are | | | | | | | |
| deactivation | released. | | | | | | | |
| Resource | The outcome of the | AF | Yes | Yes | No | No | No | No |
| allocation | resource allocation | | | | | | | |
| outcome | related to the AF | | | | | | | |
| | session. | | | | | | | |
| QoS targets | The QoS targets can | AF | No | Yes | No | No | No | No |
| can no | no longer (or can | | | | | | | |
| longer (or | again) be fulfilled by | | | | | | | |
| can again) | the network for (a part | | | | | | | |
| be fulfilled | of) the AF session. | | | | | | | |
| QoS | The QoS Monitoring | AF | No | Yes | No | No | No | No |
| Monitoring | parameter(s) (e.g. UL | | | | | | | |
| parameters | packet delay, DL | | | | | | | |
| | packet delay or round | | | | | | | |
| | trip packet delay) are | | | | | | | |
| | reported to the AF | | | | | | | |
| | according to the QoS | | | | | | | |
| | Monitoring reports | | | | | | | |
| | received from the | | | | | | | |
| | SMF. | | | | | | | |
| Out of | Credit is no longer | AF | Yes | Yes | No | No | No | No |
| credit | available. | | | | | | | |
| Reallocation | Credit has been | AF | Yes | Yes | No | No | No | No |
| of credit | reallocated after the | | | | | | | |
| | former Out of credit | | | | | | | |
| | indication. | | | | | | | |
| 5GS Bridge | 5GS Bridge | TSN AF, | No | Yes | No | No | No | No |
| information | information that has | TSCTSF | | | | | | |
| Notification | been received by PCF | | | | | | | |
| (NOTE 3) | from SMF. | | | | | | | |
| Notification | The outcome of the | AF | No | No | Yes | No | Yes | No |
| on outcome | request of service area | | | | | | | |
| of service | coverage change. | | | | | | | |
| area | | | | | | | | |
| coverage | | | | | | | | |
| change | | | | | | | | |
| Notification | The outcome of the | AF | No | No | No | No | No | Yes |
| on outcome | request for UE | | | | | | | |
| of UE | policies delivery due | | | | | | | |
| Policies | to service specific | | | | | | | |
| delivery | parameter | | | | | | | |
| | provisioning | | | | | | | |
| | procedure. | | | | | | | |
| Start of | The start or the stop | PCF | No | No | No | Yes | No | No |
| application | of application traffic | | | | | (NOTE 4) | | |
| traffic | has been detected. | | | | | | | |
| detection | | | | | | | | |
| and | | | | | | | | |
| Stop of | | | | | | | | |
| application | | | | | | | | |
| traffic | | | | | | | | |
| detection | | | | | | | | |
| Satellite | The backhaul has | AF | No | Yes | Yes | No | No | No |
| backhaul | changed between | | | | | | | |
| category | different satellite | | | | | | | |
| change | backhaul categories | | | | | | | |
| | (i.e. GEO, MEO, | | | | | | | |
| | LEO, OTHERSAT), | | | | | | | |
| | or the backhaul has | | | | | | | |
| | changed between | | | | | | | |
| | satellite backhaul and | | | | | | | |
| | non-satellite backhaul. | | | | | | | |
| Change of | The PDUID assigned | 5G | No | No | No | No | Yes | No |
| PDUID | to a UE has changed. | DDNMF | | | | | | |
| SM Policy | The establishment or | PCF | No | No | No | Yes | No | No |
| Association | termination of a SM | | | | | (NOTE 7) | | |
| established | Policy Association is | | | | | | | |
| or | reported | | | | | | | |
| terminated | | | | | | | | |

NOTE 1: Additional parameters for the subscription as well as reporting related to these events are described in 3GPP TS 23.502.
NOTE 2: Applicability of Rx is described in Annex C.
NOTE 3: 5GS Bridge information is described in clause 6.1.3.5.
NOTE 4: Bulk subscription is implicit. NOTE 1 does not apply.
NOTE 5: For a PDU Session established over a SNPN, the combination of the PLMN id and the NID identifies the SNPN.
NOTE 6: This column contains also UE context related events that are reported to other consumers such as 5G DDNMF via other reference points than N5. The Conditions for reporting column indicates the respective consumer.
NOTE 7: This PCF for the UE subscribes to this Event via AMF and SMF.

If an AF requests the PCF to report the PLMN identifier where the UE is currently located, then the PCF may provide the PLMN identifier or the SNPN identifier to the AF if available. Otherwise, the PCF may provision the corresponding PCC rules, and the Policy Control Request Trigger to report PLMN change to the SMF. The PCF may, upon receiving the PLMN identifier or the SNPN identifier from the SMF forward this information to the AF, including the PLMN Id and if available the NID. If the H-PCF requests to report the PLMN identifier where the UE is currently located, the V-PCF provisions the PCRT on “PLMN change” to the AMF as described in clause 6.1.2.5 and then forwards the PLMN ID received from the AMF to the H-PCF.

If an AF requests the PCF to report on the change of Access Type, the PCF may provide the corresponding Policy Control Request Trigger to the SMF to enable the report of the Change in Access Type to the PCF. The PCF may, upon reception of information about the Access Type the user is currently using and upon indication of change of Access Type, notify the AF on changes of the Access Type and forward the information received from the SMF to the AF. The change of the RAT Type may also be reported to the AF, even if the Access Type is unchanged. For MA PDU Session the Access Type information may include two Access Type information that the user is currently using.

If an AF requests the PCF to report on the signalling path status, for the AF session, the PCF may, upon indication of removal of PCC Rules identifying signalling traffic from the SMF report it to the AF.

If an AF requests the PCF to report Access Network Charging Correlation Information, the PCF may provide to the AF the Access Network Charging Correlation Information, which allows to identify the usage reports that include measurements for the Service Data Flow(s), once the Access Network Charging Correlation Information is known at the PCF.

If an AF requests the PCF to report Access Network Information (i.e., the User Location Report and/or the UE Timezone Report) at AF session establishment, modification or termination, the PCF may set the Access Network Information report parameters in the corresponding PCC rule(s) and provision them together with the corresponding Policy Control Request Trigger to the SMF. For those PCC rule(s) based on preliminary service information the PCF may assign the 5QI and ARP of the QoS Flow associated with the default QoS rule to avoid signalling to the UE.
NOTE 1: The PCF can also use the dynamic or pre-defined PCC Rules related to the IMS signalling to request Access Network Information reporting. This can be used to support, e.g., regulatory requirements for SMS over IP, where the IMS network (i.e., P-CSCF) needs to retrieve the user location and/or UE Time Zone information. Note that due to regulatory requirements, the Access Network Information can be requested for SMS over IP, impacting a large number of PDU Sessions, that can lead to significant increase in signalling load when the Access Network Information is requested from AMF.

The PCF may, upon receiving an Access Network Information report corresponding to the AF session from the SMF, forward the Access Network Information as requested by the AF (if the SMF only reported the serving PLMN identifier or the SNPN identifier to the PCF, as described in clause 6.1.3.5, the PCF may forward it to the AF). For AF session termination the communication between the AF and the PCF may be kept alive until the PCF report is received.

If an AF requests the PCF to report the Usage for Sponsored Data Connectivity, the PCF may provision the corresponding PCC rules, and the Policy Control Request Trigger to the SMF. If the usage threshold provided by the AF has been reached or the AF session is terminated, the PCF forwards such information to the AF.

If an AF requests the PCF to report the Service Data Flow deactivation, the PCF may report the release of resources corresponding to the AF session. The PCF may, upon being notified of the removal of PCC Rules corresponding to the AF session from the SMF, forward this information to the AF. The PCF may also forward, if available, the reason why the resources are released, the user location information and the UE Timezone.

If an AF requests the PCF to report the Resource allocation outcome, the PCF may report the outcome of the resource allocation of the Service Data Flow(s) related to the AF session. The AF may request to be notified about successful or failed resource allocation. In this case, the PCF may instruct the SMF to report the successful resource allocation trigger (see clause 6.1.3.5). If the SMF has notified the PCF that the resource allocation of a Service Data Flow is successful and the currently fulfilled QoS matches an Alternative QoS parameter set (as described in clause 6.2.2.1), the PCF may also provide to the AF the QoS Reference parameter or the Requested Alternative QoS Parameter Set which corresponds to the Alternative QoS parameter set referenced by the SMF.

If an AF requests the PCF to report when the QoS targets can no longer (or can again) be fulfilled for a particular media flow, the PCF may set the QNC indication in the corresponding PCC rule(s) that includes a GBR or delay critical GBR 5QI value and provision them together with the corresponding Policy Control Request Trigger to the SMF. At the time, the SMF notifies that GFBR can no longer (or can again) be guaranteed for a QoS Flow to which those PCC Rule(s) are bound, the PCF may report to the AF the affected media flow and provides the indication that QoS targets can no longer (or can again) be fulfilled. If additional information is received with the notification from SMF (see clause 5.7.2.4 of 3GPP TS 23.501), the PCF may also provide to the AF the QoS Reference parameter or the Requested Alternative QoS Parameter Set which corresponds to the Alternative QoS parameter set referenced by the SMF. If the SMF has indicated that the lowest priority Alternative QoS parameter set cannot be fulfilled, the PCF may indicate to the AF that the lowest priority QoS Reference or the lowest priority set of Requested Alternative QoS Parameters of the Alternative Service Requirements cannot be fulfilled.

If the AF subscribes to be notified of the QoS Monitoring reports, the PCF decides about the path for the QoS Monitoring reports and sets the QoS Monitoring for URLLC Policy Control Request Trigger accordingly, as described in clause 6.1.3.21. The PCF may further send the QoS Monitoring reports it receives from the SMF to the AF, unless the AF has provided an indication of direct event notification (i.e., in this case, the AF will receive the QoS Monitoring reports directly from the UPF).
NOTE 2: This event can only be subscribed as part of an AF session with required QoS (described in clause 6.1.3.22).

If an AF requests the PCF to report on the Out of credit event for the associated service data flow(s), the PCF may inform the AF (when it gets informed by the SMF) that credit is no longer available for the services data flow(s) related to the AF session together with the applied termination action.

If an AF requests the PCF to report on the Reallocation of credit event for the associated service data flow(s), the PCF may inform the AF (when it gets informed by the SMF) that credit has been reallocated after credit was no longer available and the termination action was applied for the service data flow(s) related to the AF session.

The PCF can arm the trigger of 5GS Bridge information available to SMF based on local policy (i.e., without an AF request) or based on subscription request from TSCTSF. The PCF may, upon reception of the 5GS Bridge information (refer to clause 6.1.3.23) from the SMF, forward this information to the TSN AF or the TSCTSF. When the PCF has received the User plane node Management Information Container or Port Management Information Container and related port number from SMF, the PCF also provides User plane node Management Information Container or Port Management Information Container and related port number to the TSN AF or TSCTSF. When SMF has reported the 5GS Bridge information and no AF session exists, the PCF forward this information to a pre-configured TSN AF, or to a pre-configured TSCTSF or a TSCTSF discovered and selected via NRF. In the case of private IPv4 address being used for IP type PDU Session, the PCF may additionally report DNN and S-NSSAI of the PDU Session to TSCTSF.

If the AF requests the PCF to report on the outcome of the service area coverage change, the PCF reports the outcome of the service area coverage change to the AF and notifies the current service area coverage to the AF. The outcome is the result of the execution of the request of service coverage change at the PCF; the outcome is successful if the request was executed, and includes the current service area coverage that may be the same or different from the service area coverage provided by the AF. The subscription may also be implicit. In this case there may be bulk subscription, either for an Internal-Group-Id or for any UE. In order to prevent massive notifications to the AF, the request for any UE is associated to a specific Application Identifier or DNN, S-NSSAI. For bulk subscription, when the AF request includes an expiration time, the PCF stops reporting to the AF when the expiration time is reached.

If the AF requests the (H-)PCF, via V-PCF when roaming, to report on the outcome of the UE Policies delivery due to service specific parameter provisioning procedure targeting a single UE, the (H-)PCF reports the outcome of the related UE Policies provisioning procedure for the related traffic descriptor for the UE to the AF, via V-PCF when roaming. The outcome of the UE Policies provisioning procedure includes the success, the failure with an appropriate cause or the interim status report such as UE is temporarily unreachable. (See clauses 4.15.6.7 and 5.2.5.7 of 3GPP TS 23.502)

A request to report Start of application traffic detection and Stop of application traffic detection triggers the reporting when the PCF receives start of application traffic detection event or stop of application traffic detection event from SMF. The reception of a subscription to this event triggers the setting of the corresponding Policy Control Request Trigger to SMF, if not already subscribed.

If an AF requests the PCF to report on the change between different satellite backhaul categories (i.e., GEO, MEO, LEO, OTHERSAT) or the change between satellite backhaul and non-satellite backhaul, the PCF may provide the corresponding Policy Control Request Trigger to the SMF to enable the report of satellite backhaul category change (see clause 6.1.3.5) to the PCF. The PCF may, upon reception of information about the change between satellite backhaul categories or change between satellite backhaul and non-satellite backhaul, notify the AF on the satellite backhaul category change event was met and forward the current satellite backhaul category information received from the SMF to the AF, or indicate that a satellite backhaul is no longer used.

If 5G DDNMF requests the PCF to report on the Change of PDUID, the PCF may notify whenever a new PDUID is allocated. Further details on how the 5G DDNMF retrieves and subscribes to notifications on Change of PDUID are defined in 3GPP TS 23.304.

A request to report SM Policy Association established or terminated triggers the reporting when the PCF receives the request for notification on the SM Policy Association from SMF. The PCF notifies on the EventID “SM Policy Association established/terminated”, includes the PCF binding information of the PCF for the PDU Session of the UE, as described in clause 6.1.1.2.2.

### 6.6.2.3 UE Procedure for Associating Applications to PDU Sessions Based on URSP

For every newly detected application the UE evaluates the URSP rules in the order of Rule Precedence and determines if the application is matching the Traffic descriptor of any URSP rule. When a URSP rule is determined to be applicable for a given application (see clause 6.6.2.1), the UE may select a Route Selection Descriptor within this URSP rule in the order of the Route Selection Descriptor Precedence.
When a valid Route Selection Descriptor is found, the UE determines if there is an existing PDU Session that matches all components in the selected Route Selection Descriptor. The UE compares the components of the selected Route Selection Descriptor with the existing PDU Session(s) as follows:
For a component which only contains one value (e.g. SSC mode), the value of the PDU Session has to be identical to the value specified in the Route Selection Descriptor.
For a component which contains a list of values (e.g., Network Slice Selection), the value of the PDU Session has to be identical to one of the values specified in the Route Selection Descriptor.
When some component(s) is not present in the Route Selection Descriptor, a PDU Session is considered matching only if it was established without including the missing component(s) in the PDU Session Establishment Request.
When the Route Selection Descriptor includes a Time Window or a Location Criteria, the PDU Session is considered matching only if the PDU Session is associated with an RSD that has the same Time Window or a Location Criteria Validity Conditions.

When a matching PDU Session exists the UE associates the application to the existing PDU Session, i.e., route the traffic of the detected application on this PDU Session.

If the UE determines that there is more than one existing PDU Session which matches (e.g., the selected Route Selection Descriptor only specifies the Network Slice Selection, while there are multiple existing PDU Sessions matching the Network Slice Selection with different DNNs), it is up to UE implementation to select one of them to use.
NOTE 1: When more than one PDU Sessions of SSC mode 3 to the same DNN and S-NSSAI exist due to PDU Session anchor change procedure as described in clause 4.3.5.2 of 3GPP TS 23.502, the UE can take the PDU Session Address Lifetime value into account when selecting the PDU Session.

If none of the existing PDU Sessions matches, the UE tries to establish a new PDU Session using the values specified by the selected Route Selection Descriptor. If the PDU Session Establishment Request is accepted, the UE associates the application to this new PDU Session. If the PDU Session Establishment Request is rejected, based on the rejection cause, the UE selects another combination of values in the currently selected Route Selection Descriptor if any other value for the rejected component in the same Route Selection Description can be used. Otherwise, the UE selects the next Route Selection Descriptor, which contains a combination of component value which is not rejected by network, in the order of the Route Selection Descriptor Precedence, if any. If the UE fails to establish a PDU Session with any of the Route Selection Descriptors, it tries other URSP rules in the order of Rule Precedence with matching Traffic descriptors, except the URSP rule with the “match-all” Traffic descriptor, if any. The UE shall not use the UE Local Configuration in this case.
NOTE 2: An application can match the Traffic Descriptor of different URSP rules and be associated with different PDU sessions simultaneously.

When the UE receives VPLMN specific URSP rules and URSP rules which are applicable to both HPLMN and VPLMN, the VPLMN specific URSP rules, corresponding to the current serving PLMN, take precedence over any other URSP rules provided to the UE. The UE determines VPLMN specific URSP Rule to be used taking serving PLMN ID into consideration. If the UE does not find a match then the UE uses the non-VPLMN specific URSP Rules.

The UE receives the updated URSP rules and (re-)evaluates their validities in a timely manner when certain conditions are met, for example:
the URSP is updated by the PCF;
the UE moves from EPC to 5GC;
change of Allowed NSSAI or Configured NSSAI;
change of LADN DNN availability;
UE registers over 3GPP or non-3GPP access;
UE establishes a connection with a ProSe Layer-3 UE-to-Network Relay;
UE establishes connection to a WLAN access.
   Details of the conditions are defined by 3GPP TS 24.526 version 18.0.0 dated 2022 Sep. 23, hereinafter “3GPP TS 24.526”.
NOTE 3: When providing the updated URSP rules to the UE with a new DNN, the PCF can set the SMF selection management trigger in the AMF to contact the PCF at PDU Session establishment (as specified in clause 6.1.2.5) if the old DNN is requested by the UE.
   The Route Selection Descriptor of a URSP rule shall be only considered valid if all of the following conditions are fulfilled:
If any S-NSSAI(s) is present, the S-NSSAI(s) is in the Allowed NSSAI for the non-roaming case and in the mapping of the Allowed NSSAI to HPLMN S-NSSAI(s) for the roaming case.
If any DNN is present and the DNN is an LADN DNN, the UE is in the area of availability of this LADN.
If Access Type preference is present and set to Multi-Access, the UE supports ATSSS.
If a Time Window is present and the time matches what is indicated in the Time Window.
If a Location Criteria is present and the UE location matches what is indicated in the Location Criteria.
If ProSe Layer-3 UE-to-Network Relay Offload indication is present and the UE supports the ProSe capability of 5G ProSe Layer-3 Remote UE.

If a matching URSP rule has no valid RSD, the UE tries other URSP rules in the order of Rule Precedence with matching Traffic descriptors, except the URSP rule with “match-all” Traffic descriptor. The UE shall not use the UE Local Configuration in this case.

When URSP rules are updated or their validity according to the conditions above change, the association of existing applications to PDU Sessions may need to be re-evaluated. The UE may also re-evaluate the application to PDU Session association due to the following reasons:
periodic re-evaluation based on UE implementation;
an existing PDU Session that is used for routing traffic of an application based on a URSP rule is released;
The expiration of Time Window in Route Selection Validation Criteria, i.e., the expiration of Time Window, or UE's location no longer matches the Location Criteria.
NOTE 4: It is up to UE implementation to avoid frequent re-evaluation due to location change.

If the re-evaluation leads to a change of the application to PDU Session association, e.g., the application is to be associated with another PDU Session or a new PDU Session needs to be established, the UE may enforce such changes in a timely manner based on implementation, e.g., immediately or when UE enters CM-IDLE state.

If the selected Route Selection Descriptor contains a Non-Seamless Offload indication and the UE has established a connection to a WLAN access, the UE routes the traffic matching the Traffic descriptor of the URSP rule via the WLAN access outside of a PDU Session.

If the selected Route Selection Descriptor contains a ProSe Layer-3 UE-to-Network Relay Offload indication and the UE has established a connection with a ProSe Layer-3 UE-to-Network Relay, the UE routes the traffic matching the Traffic descriptor of the URSP rule (including the URSP rule with the “match-all” Traffic descriptor) via the ProSe Layer-3 UE-to-Network Relay outside of a PDU session.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node comprising processing circuitry configured to:
determine a request for guidance on a rule determination associated a wireless device roaming, the determined request including at least one service parameter and a network identifier, the at least one service parameter being applicable to at least one user of a network associated with the network identifier; and
cause transmission of the request for guidance on the rule determination.

2. The network node of claim 1, wherein the network node comprises an Application Function, wherein the guidance is AF guidance, and wherein the rule determination is a user equipment route selection policy (URSP) rule determination.

3. (canceled)

4. (canceled)

5. The network node of claim 1, wherein the network is a public land mobile network, and wherein the network identifier is a PLMN identifier (ID) of an inbound roamer.

6. The network node of claim 1, wherein the network identifier is a visiting public land mobile network (VPLMN) identifier (ID) of where the at least one service parameter applies.

7. The network node of claim 6, wherein the request further comprises at least one of: a wireless device identifier, a group identifier, and a wireless device indication corresponding to any wireless device.

8. (canceled)

9. (canceled)

10. The network node of claim 1, wherein the processing circuitry is further configured to:
determine a first service request including one or both of a target wireless device set to inbound roamer of at least one Public Land Mobile Network (PLMN) ID and at least one PLMN ID of inbound roamer PLMNs associated with the guidance on rule determination.

11. The network node claim 1, wherein the processing circuitry is further configured to:
differentiate a second service request from a third service request, the second service request being associated with at least one wireless device of a PLMN of a Network Exposure Function (NEF) that an AF provides information to when the at least one wireless device roams to other PLMNs, the third service request being associated with inbound roamer wireless devices from other PLMNs.

12. The network node of claim 11, wherein the differentiating includes providing equipment route selection policy information that either:
targets an inbound roamer from a PLMN ID; or
targets an outbound roamer when the outbound roamer is roaming into a visited PLMN ID, the outbound roamer being at least one of a subscriber, a wireless device, a group of wireless devices, and any wireless device of a same PLMN of the NEF.

13. A method implemented by a network node, the method comprising:
determining a request for guidance on a rule determination associated with wireless device roaming, the determined request including at least one service parameter and a network identifier, the at least one service parameter being applicable to at least one user of a network associated with the network identifier; and
causing transmission of the request for guidance on the rule determination.

14. The method of claim 13, wherein the network node comprises an Application Function, wherein the guidance is AF guidance, and wherein the rule determination is a user equipment route selection policy (URSP) rule determination.

15. (canceled)

16. (canceled)

17. The method of claim 13, wherein the network is a public land mobile network, and wherein the network identifier is a PLMN identifier (ID) of an inbound roamer.

18. The method of claim 13, wherein the network identifier is a visiting public land mobile network (VPLMN) identifier (ID) of where the at least one service parameter applies.

19. The method of claim 18, wherein the request further comprises at least one of: a wireless device identifier, a group identifier, and a wireless device indication corresponding to any wireless device.

20. (canceled)

21. (canceled)

22. The method of claim 13, further comprising:
determining a first service request including one or both of a target wireless device set to inbound roamer of at least one Public Land Mobile Network (PLMN) ID and at least one PLMN ID of inbound roamer PLMNs associated with the guidance on rule determination.

23. The method of claim 13, further comprising:
differentiating a second service request from a third service request, the second service request being associated with at least one wireless device of a PLMN of a Network Exposure Function (NEF) that an AF provides information to when the at least one wireless device roams to other PLMNs, the third service request being associated with inbound roamer wireless devices from other PLMNs.

24. The method of claim 23, wherein the differentiating includes providing equipment route selection policy information that either:
targets an inbound roamer from a PLMN ID; or
targets an outbound roamer when the outbound roamer is roaming into a visited PLMN ID, the outbound roamer being at least one of a subscriber, a wireless device, a group of wireless devices, and any wireless device of a same PLMN of the NEF.

25. A network node comprising processing circuitry configured to:
determine a user equipment route selection policy (URSP) for a wireless device based on whether the wireless device is an inbound roamer or an outbound roamer;
when the wireless device is an inbound roamer:
read service data using a first key, the first key being a wireless device public land mobile network (PLMN) identifier;
transmit first service parameters corresponding to the service data to a home policy control function (H-PCF);
when the wireless device is an outbound roamer:
read second service parameters using a second key, the second key being at least one of: a wireless device ID, a group ID of the wireless device, and any wireless device from a home UDR; and
verify whether the second service parameters are applicable when the wireless device is roaming in a visited PLMN ID (VPLMNID).

26. The network node of claim 25, wherein the processing circuitry is further configured to:
cause transmission of a request for guidance to a user data repository (UDR); and
receive the guidance in response to the request, wherein the guidance is Application Function (AF) guidance.

27. The network node of claim 25, wherein the processing circuitry is further configured to retrieve the first service parameters when a Subscriber Permanent Identifier (SUPI) of a public land mobile network (PLMN) one of registers or is available.

28. The network node of claim 27, wherein the processing circuitry is further configured to one of query or subscribe the wireless device using a network identifier associated with the wireless device.

29. (canceled)

30. The network node of claim 25, wherein the network identifier is a PLMN identifier, ID, that indicates a target of an Application Function, AF, request.

31. The network node of claim 25, wherein the network node comprises a Policy Control Function (PCF).

32. (canceled)

33. A method implemented by a network node, the method comprising:
determining a user equipment route selection policy (URSP) for a wireless device based on whether the wireless device is an inbound roamer or an outbound roamer;
when the wireless device is an inbound roamer:
reading service data using a first key, the first key being a wireless device public land mobile network (PLMN) identifier (ID);
transmitting first service parameters corresponding to the service data to a home policy control function (H-PCF);
when the wireless device is an outbound roamer:
reading second service parameters using a second key, the second key being at least one of: a wireless device ID, a group ID of the wireless device, and any wireless device from a home UDR; and
verifying whether the second service parameters are applicable when the wireless device is roaming in a visited PLMN ID.

34. The method of claim 33, further comprising:
causing transmission of a request for guidance to a user data repository (UDR); and
receiving the guidance in response to the request, wherein the guidance is Application Function (AF) guidance.

35. The method of claim 33, further comprising retrieving the first service parameters when a Subscriber Permanent Identifier (SUPI) of a public land mobile network (PLMN) one of registers or is available.

36. The method of claim 35, further comprising one of querying or subscribing the wireless device using a network identifier associated with the wireless device.

37. (canceled)

38. The method of claim 33, wherein the network identifier is a PLMN identifier (ID) that indicates a target of an Application Function (AF) request.

39. The method of claim 33, wherein the network node comprises a Policy Control Function (PCF).

40. (canceled)
